(19) United States
(12) Patent Application Publication
(10) Pub. No.: US 2021/0226247 A1
(43) Pub. Date: Jul. 22, 2021

(54) COMPOSITE SOLID ELECTROLYTES FOR HIGH-PERFORMANCE METALLIC OR METAL-ION BATTERIES

(71) Applicant: North Carolina State University, Raleigh, NC (US)

(72) Inventors: Xiangwu Zhang, Raleigh, NC (US); Chaoyi Yan, Raleigh, NC (US); Mahmut Dirican, Raleigh, NC (US)

(21) Appl. No.: 17/096,457

(22) Filed: Nov. 12, 2020

Related U.S. Application Data
(60) Provisional application No. 62/936,385, filed on Nov. 15, 2019.

(51) Int. Cl. H01M 10/0562; H01M 10/0525; H01M 10/0565; H01M 4/505; H01M 4/525; H01M 4/58

(52) U.S. Cl. CPC H01M 10/0562; H01M 10/0525; H01M 10/0565; H01M 2004/028; H01M 4/525; H01M 4/58; H01M 4/505

(57) ABSTRACT

Composite solid electrolytes (CSE) and metal or metal ion energy storage devices that include a CSE are provided. The CSE can include silane-decorated ceramic nanofibers a polymeric material, and a plurality of metal ions. The energy storage device includes a CSE operably coupled with an anode and a cathode. Methods for making a composite solid electrolyte are also provided.

### CROSS-REFERENCE TO RELATED APPLICATIONS

This application claims the benefit of and priority to U.S. Provisional Application Ser. No. 62/936,385, having the title “COMPOSITE SOLID ELECTROLYTES FOR HIGH-PERFORMANCE METALLIC OR METAL-ION BATTERIES”, filed on Nov. 15, 2019, the disclosure of which is incorporated herein by reference in its entirety.

### STATEMENT REGARDING FEDERALLY SPONSORED RESEARCH

The present invention was made with United States Government support under grant no. DE-EE0007806 awarded by the U.S. Department of Energy. The United States Government has certain rights in the invention.

### BACKGROUND

Conventional lithium ion storage cells require a liquid electrolyte and a separator and cannot meet the growing demand for energy consumption in large-scale devices, such as electric vehicles and grid energy storage systems. In a conventional lithium-ion cell, the separator is typically immersed in a liquid electrolyte which fills the space between anode and cathode in entirety and promotes the flow of metal ions between the electrodes. Recently, attempts have been made to replace the liquid electrolyte and separator with a solid electrolyte material. Such composite solid electrolytes (CSEs), which are composed of inorganic fillers and organic polymers, show improved safety and suppressed lithium dendrite growth in Li-metal batteries, as compared to flammable liquid electrolytes. However, the performance of current CSEs is limited by an agglomeration effect, with low content of inorganic Li⁺-conducting fillers and ineffective Li⁺ transport between the inorganic fillers and the polymer matrix.

### SUMMARY

Embodiments of the present disclosure provide composite solid electrolytes, energy storage devices including composite solid electrolytes, methods of making composite solid electrolytes and the like.

An embodiment of the present disclosure can include a composite solid electrolyte (CSE) including a plurality of silane-decorated ceramic nanofibers, a polymeric material, and a plurality of metal ions. The silane-decorated ceramic nanofibers can include ceramic nanofibers coupled with a silane-coupling agent that has an organofunctional group.

An embodiment of the present disclosure also includes a metallic or metal ion energy storage device comprising a CSE as above, wherein the composite solid electrolyte can be operably coupled with an anode and a cathode.

An embodiment of the present disclosure also includes a method for making a composite solid electrolyte (CSE). The method can include combining a plurality of silane-decorated ceramic nanofibers as above with a polymeric material or prepolymer material and a plurality of metal ions to form a mixture, forming a film with the mixture, and polymerizing the mixture to provide a polymer matrix comprising the silane-decorated ceramic nanofibers and the polymeric material.

Other compositions, apparatus, methods, features, and advantages will be or become apparent to one with skill in the art upon examination of the following drawings and detailed description. It is intended that all such additional compositions, apparatus, methods, features and advantages be included within this description, be within the scope of the present disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 is a chematic drawing of the synthesis procedures of s@LLAZO-PEGDA CSEs in accordance with embodiments of the present disclosure.

FIG. 2 is a schematic drawing of rolled-up fabrication of high-performance, solid-state Li-ion batteries in accordance with embodiments of the present disclosure.

FIGS. 3A-3C are digital images of (FIG. 3A) s@LLAZO-PEGDA CSE, (FIG. 3B) LFP cathode coated with s@LLAZO-PEGDA CSE, and (FIG. 3C) free-standing s@LLAZO-PEGDA CSE films in accordance with embodiments of the present disclosure.

FIG. 4 is a schematic of synthesis procedure of s@LLAZO-PEGDA CSEs with percolated s@LLAZO network in the composite electrolyte, providing fast and non-tortuous Li+ conductive pathways in accordance with embodiments of the present disclosure.

FIG. 5A is a SEM image of calcined LLAZO nanofibers and FIG. 5B provides XRD patterns of calcined LLAZO nanofibers in accordance with embodiments of the present disclosure.

FIGS. 6A-6E are TEM images of (FIG. 6A) LLAZO, (FIG. 6B) s@LLAZO(3 h), (FIG. 6C) s@LLAZO(6 h), (FIG. 6D) s@LLAZO(12 h), and (FIG. 6E) s@LLAZO(24 h) nanofibers. FIG. 6F is XPS spectra (C 1s, O 1s, Li 1s, Si 2p) of LLAZO nanofibers and s@LLAZO(6 h) nanofibers. FIG. 6G shows Arrhenius plots of LLAZO-40PEGDA and s@LLAZO-40PEGDA CSEs. FIG. 6H shows Ionic conductivities of s@SiO2(6 h)-PEGDA, s@TiO2(6 h)-PEGDA, and s@LLAZO(6 h)-PEGDA CSEs with different filler contents. FIG. 6I shows stress-strain curves of LLAZO-60PEGDA and s@LLAZO-60PEGDA CSEs.

FIG. 7 shows FTIR spectra of LLAZO and s@LLAZO nanofibers with different silane treatment times (3-24 h) in accordance with embodiments of the present disclosure.

FIG. 8 shows TGA curves of s@LLAZO nanofibers with different silane treatment times (3-24 h) in accordance with embodiments of the present disclosure.

FIG. 9 shows EIS profiles of LLAZO-40PEGDA CSE, and s@LLAZO-40PEGDA CSEs with different silane treatment time (3-24 h) in accordance with embodiments of the present disclosure.

FIGS. 10A-10F are SEM images of (FIGS. 10A-10B) LLAZO-40PEGDA CSE, (FIG. 10) s@LLAZO(3 h)-40PEGDA, (FIG. 10D) s@LLAZO(6 h)-40PEGDA, (FIG. 10E) s@LLAZO(12 h)-40PEGDA, and (FIG. 10F) s@LLAZO(24 h)-40PEGDA CSEs in accordance with embodiments of the present disclosure.

FIG. 11 provides Arrhenius plots of s@LLAZO(6 h)-PEGDA CSEs with different filler contents in accordance with embodiments of the present disclosure.

FIG. 12A is a digital image of s@LLAZO(6 h)-60PEGDA CSE, FIG. 12B shows linear sweep voltammetry curves of PEGDA, LLAZO-90PEGDA, and s@LLAZO(6 h)-60PEGDA CSEs, FIG. 12C shows DC polarization curves and FIG. 12D shows lithium plating/striping cycles of symmetric Li|s@LLAZO(6 h)-60PEGDA|Li cell.

FIG. 13 provides digital images of bending test for s@LLAZO-60PEGDA CSE in accordance with embodiments of the present disclosure.

FIG. 14 provides LSV curves of s@LLAZO(6 h)-60PEGDA CSE in accordance with embodiments of the present disclosure.

FIGS. 15A-15B show (FIG. 15A) EIS profiles and (FIG. 15A) cycling performance (at 0.5C) of all-solid-state Lils@LLAZO(6 h)-PEGDA|LiFePO4 cells with different concentration of s@LLAZO nanofibers, (FIG. 15C) cycling performance (at 1C), (FIG. 15D) EIS profiles (before and after cycles), (FIG. 15E) rate capability (0.2-10 C) and (FIG. 15F) charge-discharge profiles (at different C rates) of all-solid-state Li|s@LLAZO(6 h)-60PEGDA|LiFePO4 cell operated at 25° C.

FIG. 16A shows cycling performance (at 0.5C), and FIG. 16B shows rate capability (0.2-5C) of all-solid-state Li|s@LLAZO(6 h)-60PEGDA|NMC and liquid Li|EC/DMC-(LiPF6)|NMC cells operated at 25° C.

FIG. 17 provides charge-discharge profiles (at 0.2-5 C) of an all-solid-state Li' s@LLAZO(6 h)-60PEGDA|NMC cell operated at 25° C. in accordance with embodiments of the present disclosure.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

The present disclosure relates, generally, to a solid electrolyte for use in a metal or metal-ion energy storage cell, such as a Lithium-ion battery. During charging of a conventional metal-ion energy storage cell, electrons flow from an external voltage source and metal cations flow through a liquid electrolyte toward the anode. When the cell is discharged, the metal cations flow through the electrolyte and the electrons flow from the anode to the cathode through a load. In order to avoid a short circuit within the energy storage cell, a separator is disposed between the two electrodes. The separator is an electrically insulating material that also is generally permeable to the metal cations. In a conventional lithium-ion cell, the separator is typically immersed in a liquid electrolyte which fills the space between anode and cathode in entirety and promotes the flow of metal ions between the electrodes. Recently, attempts have been made to replace the liquid electrolyte and separator with a solid electrolyte material.

In the preparation of lithium metal batteries, composite solid electrolytes (CSEs), which are composed of inorganic fillers and organic polymers, show improved safety and suppressed lithium dendrite growth in Li-metal batteries, as compared to flammable liquid electrolytes. However, the performance of current CSEs is limited by an agglomeration effect, with low content of inorganic Li⁺-conducting fillers and ineffective Li⁺ transport between the inorganic fillers and the polymer matrix. To address these challenges, disclosed here is a CSE composed of silane-modified Li_{6.28}La₃Al_{0.24}Zr₂O₁₂ (s@LLAZO) nanofibers and poly(ethylene glycol) diacrylate (PEGDA). Employment of the silane-coupling agent enables the incorporation of a high content of LLAZO nanofibers (up to 60 wt %) with the polymer matrix and results in a well-percolated, three-dimensional LLAZO network fully embedded in the PEGDA matrix. As a result, the silane-coupling agent successfully eliminates the agglomeration effect, which ensures higher ionic conductivity, larger lithium transference number, wider electrochemical stability window, and better cycling stability for s@LLZAO-PEGDA CSEs. The all-solid-state LiILiFePO₄ and Li|Li[Ni_{1/3}Mn_{1/3}Co_{1/3}]O₂ cells demonstrate excellent cycling stability and extraordinarily high rate capability up to 10 C at ambient temperature. This novel design of CSEs with s@LLAZO nanofibers paves the way for a new generation of improved functioning all-solid-state Li-metal batteries.

Current Li-ion batteries using an intercalation mechanism exhibit limited energy density which cannot meet the growing demand for energy consumption in large-scale devices, such as electric vehicles and grid energy storage systems. Li metal, owing to its high energy density (3860 mAh g⁻¹) and low potential (−3.04 V vs. a standard hydrogen electrode), would be the most suitable anode. Unfortunately, it cannot be used in liquid electrolyte-based Li batteries due to undesirable formation of Li-dendrites. (Refs. 1,2,3,4) The replacement of flammable, organic liquid electrolytes with solid-state electrolytes is regarded as a viable solution to overcome the problem of dendrite formation and fundamentally improve safety when utilizing Li metal anodes. (Refs. 5,6) Additionally, the relatively wider electrochemical stability window of solid electrolytes allows for use in conjunction with high-voltage cathode materials, which can further improve the overall energy density. (Refs. 5,6,7)

Certain electrolytes using polymeric Li⁺-conductors have been disclosed, for example, first using poly(ethylene oxide) with the association of Li salts, and then with other solid polymer electrolytes such as polyacrylonitrile, poly(methyl methacrylate), and poly(vinylidene fluoride). (Refs. 5,8,9) Although polymer electrolytes demonstrated the feasibility of all-solid-state Li batteries, their low ambient ionic conductivities hindered their practical use. (Refs. 10,11) Reasonable ionic conductivities could only be reached at elevated temperatures near the melting point of the polymer, but operation at this elevated temperature reduced mechanical strength, and increased the risk of Li dendrite formation. (Refs. 5,12,13) Therefore, attention was turned to inorganic Li⁺-conductors including lithium oxides and lithium sulfides. (Refs. 6,14) These showed relatively low activation energy via ion-hopping mechanisms, leading to high ionic conductivity and potentially high rate-capability in battery applications. (Ref. 15) Among various inorganic Li⁺-conductors, garnet-type (Li₇La₃Zr₂O₁₂, LLZO) ceramics showed high ionic conductivity and excellent stability against colder temperature or exposure to air in use with Li metal. (Refs. 14,16,17) However, the high rigidity of LLZO led to low flexibility and poor interfacial contact with Li metal. (Ref. 17)

In order to take advantage of the properties of both polymers and ceramics while avoiding their respective limitations, ceramics have been incorporated into a polymer matrix to form composite solid electrolytes (CSEs). In doing so, the ionic conductivity was remarkably improved by dispersing Li⁺-conducting fillers into the polymer matrix (˜10⁻⁴ S cm⁻¹), with the resultant CSEs showing improved flexibility and good interfacial contact. (Refs. 18,19) However, severe agglomeration of particles was found at a high level of particulate inorganic fillers. Consequently, only a low volume fraction of fillers were typically used in these CSEs, which led to difficulty in forming well-percolated ceramic networks. (Refs. 20,21,22) In most cases, the inorganic Li⁺-conductors worked as regular fillers to diminish the crystallinity of the polymers, and the overall electrochemical performance of such CSEs were mainly driven by the polymer properties. (Ref. 18) As a result, the low utilization of inorganic Li⁺-conductors in CSEs greatly restricted the electrochemical stability and cycling-stability owing to the dual-ion conducting behavior of polymer electrolytes. More importantly, the high activation energy of Li⁺ conduction toward polymer segmental motion extensively hindered the rate performance of solid-state batteries with polymer rich CSEs.

In view of the foregoing, we disclose a CSE based mainly on inorganic Li-conductors, with supplementary polymer content for improving interfacial contact. This new type of CSE can enrich inorganic Li-conductors and provide an improved percolated network.

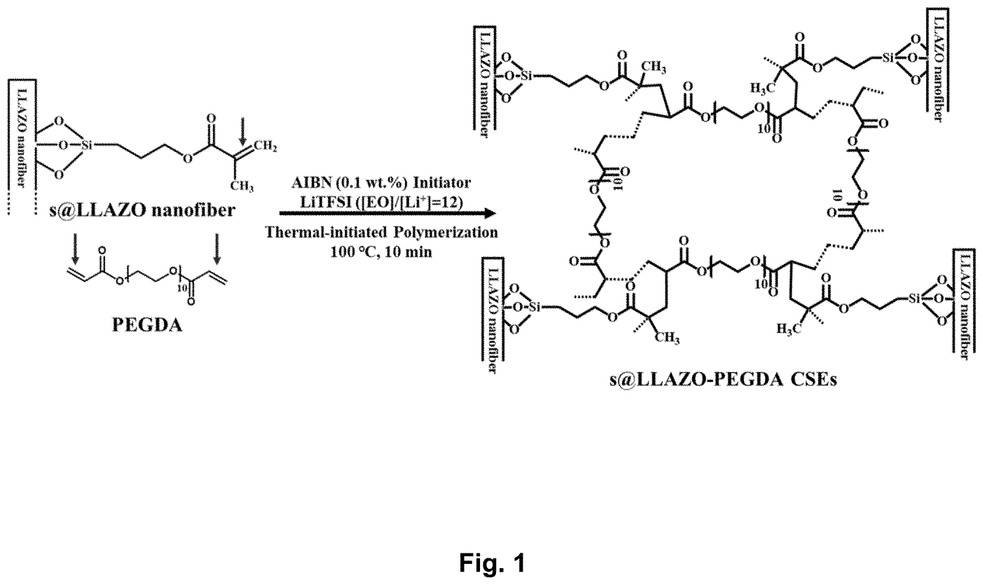

In one aspect the disclosed CSE includes a polymer matrix that incorporates inorganic Li-conductor fibers. One-dimensional Li_{6.28}La₃Al_{0.24}Zr₂O₁₂ (LLAZO) nanofibers can be used in the CSE to provide long-range and fast Li⁺ conduction. The LLAZO nanofibers utilize a silane-coupling agent disposed on at least a portion of the nanofiber structure (s@LLAZO), resulting in a silane-decorated nanofiber, which enables the chemical grafting of functional monomers directly to the nanofiber surface. In some aspects, acrylate functional groups (CH₂═CHCOO⁺) are covalently bonded on the surface of LLAZO nanofibers, which enables the chemical grafting of one or more additional functional monomers or polymers directly from the nanofiber surfaces. In the resultant composite electrolytes, silane-decorated LLAZO nanofibers (s@LLAZO nanofibers) can be polymerized and/or cross-linked along with one or more additional monomers or polymers to form the CSE. A representative schematic showing the polymerization and crosslinking of s@LLAZO-PEGDA CSEs is provided in FIG. 1. We believe this may be the ultimate solution toward high-performance, all-solid-state Li-metal batteries. (Ref. 22)

The controlled fabrication of composite structures can provide a well-percolated inorganic network, forming continuous, 3-dimensional, and fast Li⁺ conductive pathways within the CSE. The silane-coupling agent prevents the inhomogeneous distribution of inorganic Li⁺ conductors and enhances the interaction between the LLAZO nanofibers and the polymer matrix, (Ref. 22) which improves the mechanical strength of CSE, favors the amorphization of polymer, and reduces the activation energy of Li⁺ conduction between filler and polymer. Consequently, the disclosed CSEs exhibit higher ionic conductivity, larger lithium transference number, wider electrochemical stability window, and better cycling stability. All-solid-state Li|LiFePO₄ cells utilizing the disclosed CSE show excellent stability and remarkable rate-capability at a high current density of 10 C at ambient temperature. More importantly, this design enables the maximized utilization of garnet nanofibers, which exceeds the oxidation limit of other CSEs to 5.2V and further supports it to be applied in a high-voltage cathode (e.g., Li[Ni_{1/3}Mn_{1/3}Co_{1/3}]O₂, NMC) for higher energy density. All-solid-state Li|NMC cells utilizing the disclosed CSE exhibit superior cycling performance as compared to similar cells using liquid electrolyte, further demonstrating the success in the disclosed CSEs with controlled percolation-network of garnet nanofibers.

### A. Composite Solid Electrolyte

Having described generally the benefits of the disclosed CSE, we turn to the details of exemplary CSEs. In one aspect, the disclosure relates to a composite solid electrolyte (CSE) comprising a plurality of ceramic nanofibers in a polymer matrix.

In aspects, the disclosed CSE comprises a plurality of ceramic nanofibers. Exemplary ceramic nanofibers can comprise inert ceramics (e.g., Al₂O₃, TiO₂, SiO₂, and the like), ferroelectric ceramics (e.g., LiNbO₃, PbTiO₃ and BaTiO₃), clay, or fast ion conductors. Exemplary ion conductors include garnet-type ceramics, perovskite-type ceramics, NASICON-type ceramics (sodium super ion conductors), and sulfide-type ceramics. In various aspects, the ceramic nanofiber is a garnet-type ceramic nanofiber. In some aspects, the garnet-type ceramic nanofiber is Li₇La₃Zr₂O₁₂ (LLZO), or Li_{6.28}La₃Al_{0.24}Zr₂O₁₂ (LLAZO), or Li_{6.75}La₃Zr_{1.75}Ta_{0.25}O₁₂ (LLZTO). With a large specific surface area, nanoscale garnet-type ceramic nanofibers improve the transition rate of ions.

In various aspects, a silane-coupling agent is attached to at least a portion of the surface of the ceramic nanofiber. The silane-coupling agent enables grafting of at least one functional monomer to the surface of the ceramic nanofiber. By incorporating the functional monomer onto the inorganic surface of the ceramic nanofiber, the nanofiber may be polymerized with one or more additional monomers or polymers. The silane-coupling agent thereby enables incorporation of the ceramic fibers into a polymer matrix, without agglomeration of the ceramic fibers.

In aspects, the silane-coupling agent has a general structure:

(RO)₃—Si—R′—X

where: RO is a hydroxyl group or a hydrolysable group such as an alkoxy group; R′ is a C2-C6 alkyl linkage; and X is an organofunctional group.

In aspects, the hydroxyl or alkoxy groups can form a strong bond with one or more inorganic materials on the surface of the ceramic nanofiber. For example, one or more of the alkoxy groups on the silane group can hydrolyze with water to produce silanol groups, and the resulting silanol can coordinate with metal hydroxyl groups on the inorganic surface of the ceramic nanofiber to form an oxane bond, with the elimination of water. The grafting density of the silane-coupling agent to the nanofiber can be controlled, for example, by controlling the rate of hydrolysis and condensation of the silane coupling agent. In various aspects, the silane-coated ceramic nanofibers include from about 1% to about 15% (by weight) of silane-coupling agent.

Once a silane-coupling agent is attached to the surface of the nanofiber, the surface can take on one or more of the properties of the organofunctional group. In aspects, the organofunctional group enables polymerization and/or cross-linking with one or more corresponding monomers or polymers to form the polymer matrix. In various aspects, the organofunctional group comprises a carbonyl, an alcohol, a carboxylic acid, an ester, an amine, a vinyl, an allyl, a methacryloxy, an epoxy functional group, or a combination thereof. One of skill in the art would understand how to select an organofunctional group that would provide the necessary or desired functionality for the intended polymer matrix. In an aspect, the organofunctional group is an acrylate functional group.

In aspects, the silane-coated ceramic nanofiber is polymerized and/or cross-linked with a polymeric material or precursor thereof. The polymeric material can comprise any polymer having properties described herein, including electrochemical performance, safety, flexibility, process ability and suitability for batteries. Exemplary polymeric materials include polymers or copolymers of polyethylene oxide (PEO), polycarbonate, polysiloxane, polyvinyl chloride (PVC), polyacrylonitrile (PAN), poly(methyl methacrylate) (PMMA), polyvinylidene fluoride (PVDF), Poly(vinylidene fluoride-co-hexafluoropropylene) (PVDF-HFP), polypropylene glycol (PPG), polydimethylsiloxane (PDMS), polyethylene carbonate (PEC), polypropylene carbonate (PPC), polycaprolactone (PCL), polytrimethylene carbonate (PTMC), or combinations thereof. In certain aspects, the polymer matrix is obtained by reacting a polyethylene glycol with acrylic or methacrylic acid. In certain aspects, the polymeric material comprises a poly(ethylene glycol) diacrylate (PEGDA) material.

According to the various aspects, the polymer precursor or polymeric material can comprise any material that can be polymerized and/or cross-linked with the organofunctional group in the silane-coupling agent to provide a polymer matrix in which the ceramic nanofiber is dispersed.

In various embodiments, the polymeric material has a weight-average molecular weight of from about 200 to about 50000 Daltons. In various aspects, the polymeric material has a glass transition temperature (T_{g}) of from about −65° C. to about 85° C.

According to various aspects, a plurality of metal ion salts may be dispersed within the CSE. Exemplary metal ion salts include any of a variety of known metal ion salts. Exemplary lithium-ion salts include, for example, bis(trifluoromethane)sulfonimide lithium salts (LiTFSI).

According to various aspects, the disclosed CSE comprises from about 5% to about 70% (by weight) ceramic nanofibers. According to various aspects, the disclosed CSE comprises from about 30% to about 95% (by weight) polymer. According to various aspects, the disclosed CSE comprises from about 1% to about 30% (by weight) metal ion salts.

### B. Method of Making Composite Solid Electrolyte

Various aspects include making the disclosed CSE. The disclosed CSE can be made into a coating or a free-standing solid thin film. According to aspects, the ceramic nanofibers are prepared by disposing the silane-coupling agent on at least a portion of the surface of the ceramic nanofibers to produce silane-coated or silane-decorated nanofibers. Then the silane-coated ceramic nanofibers are combined with the polymer or polymer precursor and Li salt to form a mixture. In some aspects, the silane-coated ceramic nanofibers are dispersed homogeneously throughout the mixture.

No materials other than the silane-coated ceramic nanofibers and the polymeric material or precursor need be present in the mixture to form the CSE. However, as will be recognized by those skilled in the art, chemical initiators or additives such as surfactants may be added to the mixture in minimal amounts. The mixture may also include additional materials to provide additional improvements in properties such as ionic conductivity, mechanical strength, flexibility, and the like. The mixture may then be formed into a film. For example, to produce a free-standing film, the mixture can be poured into a mold or extruded to form a film. In some aspects, the mixture may be coated directly onto an electrode material. The mixture may be polymerized. In the case where the polymeric material is a radiation cured polymerizable or crosslinkable material, the mixture is passed through a source of actinic radiation. Similarly, if the polymeric material is a thermally cured polymerizable or crosslinkable material, the mixture is heated to initiate polymerization.

The term “actinic radiation” as used herein includes the entire electromagnetic spectrum and electron beam and gamma radiation. It is anticipated, however, based on availability of radiation sources and simplicity of equipment that electron beam and ultraviolet radiation will be used most often. Electron beam and gamma radiation are advantageous because they do not require the presence of a photoinitiator. When a photoinitiator is required, for example when using ultraviolet radiation, any conventional initiator may be used. When using electron beam, the beam potential must be sufficiently high to penetrate the electrode layer, the anode or cathode half element, or the cell itself depending upon which manufacturing technique is adopted. Voltages of 175 to 300 KV are generally useful. The beam dosage and the speed with which the element traverses the beam are adjusted to control the degree of crosslinking in an otherwise known manner.

In aspects, the resulting CSE film thickness can be from about 10 microns to about 100 microns. The resulting CSE film can be coated directly onto an electrode, and/or operably coupled with a cathode and anode. For example, in some aspects the CSE may be formed as a free-standing film and laminated under heat and pressure between cathode and anode half elements. A conductive adhesive may be used if necessary, although not required.

In aspects, the composite solid electrolyte in a sheet form. The CSE can be flexible and bendable. The composite solid electrolyte can have an electrical conductivity of about 10⁻⁷S cm⁻¹ or less.

### C. Metallic or Metal Ion Battery

In one aspect, the disclosure relates to a solid-state metallic or metal ion energy storage device, such as a battery, that includes the disclosed CSE. The disclosed energy storage device is preferably a lithium, magnesium, aluminum, potassium, sodium storage device. In some aspects, the energy storage device is a lithium storage device. While various aspects described herein are in reference to lithium ions and lithium energy storage devices, it will be understood that reference to lithium (e.g., lithium-ion or lithium metal anode) may be substituted for magnesium, aluminum, potassium, or sodium in the context of magnesium, aluminum, potassium, sodium storage devices, respectively.

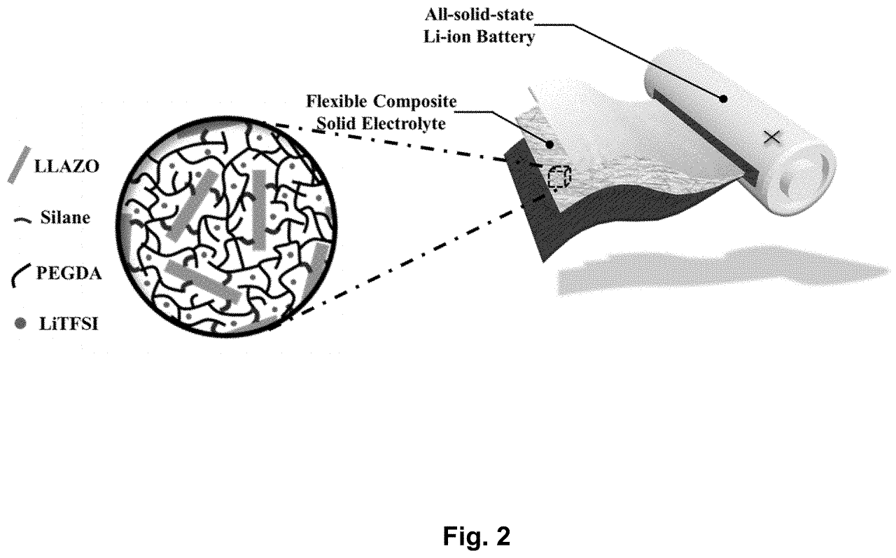

Referring to FIG. 2, according to some aspects, a solid-state metal ion battery can comprise a cathode layer, an anode layer, and a CSE layer disposed between the anode and cathode layer.

According to the aspects, any known anode materials can be used. For lithium-ion energy storage devices, exemplary anode materials include: graphite, Lithium Titanate (Li₂TiO₃) (LTO), silicon, lithium metal.

According to the aspects, any known cathode materials can be used. For lithium-ion energy storage devices, exemplary cathode materials include: Lithium Iron Phosphate (LiFePO₄) (LFP); Lithium Nickel Manganese Cobalt Oxide (LiNiMnCoO₂) (NMC); Sulfur (S); Lithium Polysulfide (Li₂Sₓ), Lithium Cobalt Oxide (LiCoO₂) (LCO); Lithium Manganese Oxide (LiMn₂O₄ or Li₂MnO₃) (LMO); Lithium Nickel Cobalt Aluminum Oxide (LiNiCoAlO₂) (NCA); Iron Fluoride (FeF₂); Copper Flouride (CuF₂); Nickel Flouride (NiF₂); Cobalt Flouride (CoF₂); Selenium (Se); Lithium Selenide (Li₂Se); Tellurium (Te); Dilithium Telluride (Li₂Te); Iodine (I₂); Lithium Iodide (Lil); Bromine (Br₂); Lithium Bromide (LiBr); Oxygene (O₂, lithium-airbattery).

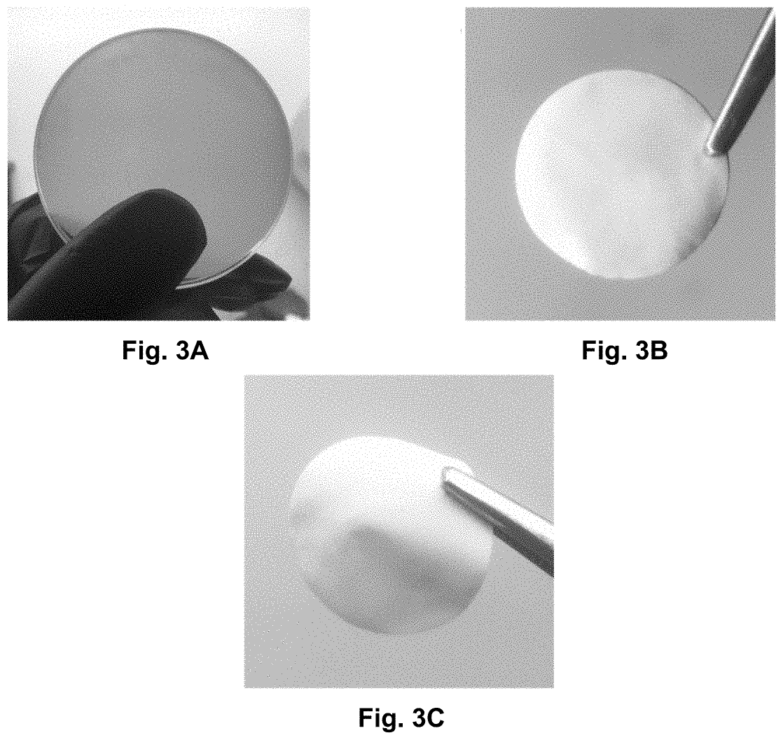

According to the aspects, the CSE material is in sheet form, having a first side that is operably coupled with the anode material, and a second side that is operably coupled with the cathode material. In some aspects, the CSE material may be coated onto the anode material and/or the cathode material (see, e.g., FIG. 3B showing an LFP cathode coated with s@LLAZO-PEGDA CSE). In some aspects, the CSE material may be provided as a free-standing material, and laminated to the anode material and/or the cathode material.

Before proceeding to the Examples, it is to be understood that this disclosure is not limited to particular aspects described, and as such may, of course, vary. Other systems, methods, features, and advantages of foam compositions and components thereof will be or become apparent to one with skill in the art upon examination of the drawings and detailed description. It is intended that all such additional systems, methods, features, and advantages be included within this description, be within the scope of the present disclosure, and be protected by the accompanying claims. It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

### D. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Preparation of Exemplary CSEs

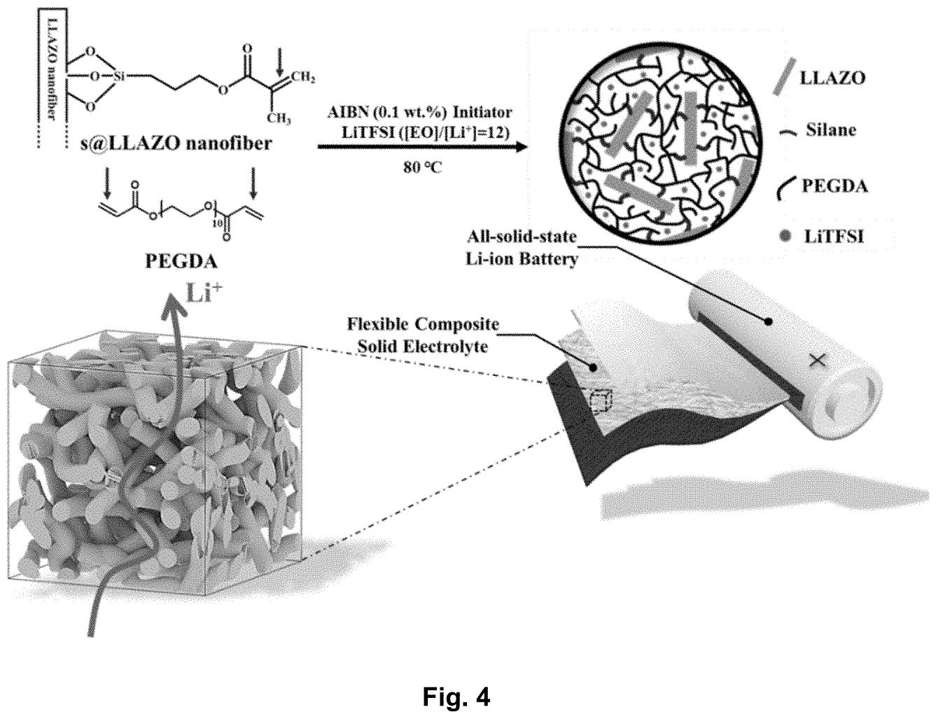

Silane-decorated LLAZO nanofibers (s@LLAZO) were obtained by a hydrolysis reaction with different grafting densities. As illustrated in FIG. 4, owing to the grafted acrylate functional groups on LLAZO nanofibers, a controlled organic-inorganic cross-linked network was obtained via chain-growth polymerization of s@LLAZO nanofibers and poly(ethylene glycol) diacrylate (PEGDA) monomers. The well-controlled composite structure ensured the formation of a percolated network with Li⁺ conductors, supporting a highly conductive Li⁺ pathway. Conduction of Li⁺ occurred inside and along the surface of percolated LLAZO nanofibers. Moreover, the increased binding force and decreased interfacial resistance between the polymer and inorganic nanofibers enabled the fabrication of CSEs with a high content of inorganic Li⁺ conductors. Free-standing films with different silane treatment times and polymer contents were prepared and denoted as s@LLAZO(x)-nPEGDA, where x represents the silane treatment time and n is the weight content of PEGDA polymer.

2. Characterization of Silane-Coated LLAZO Nanofibers and CSEs

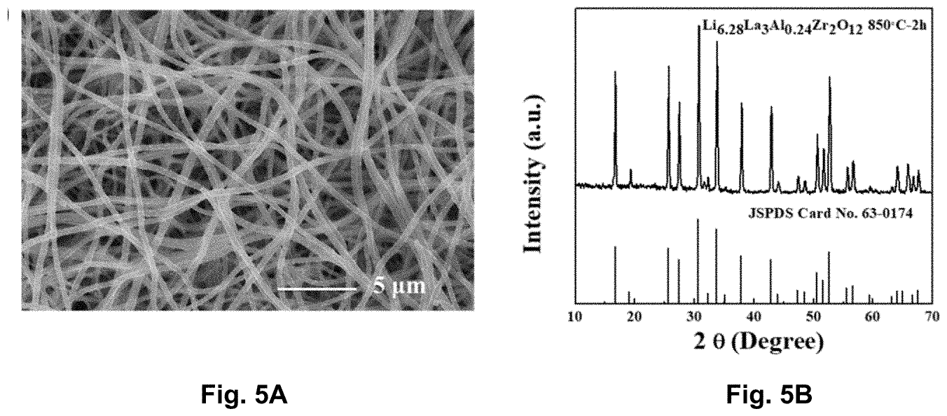

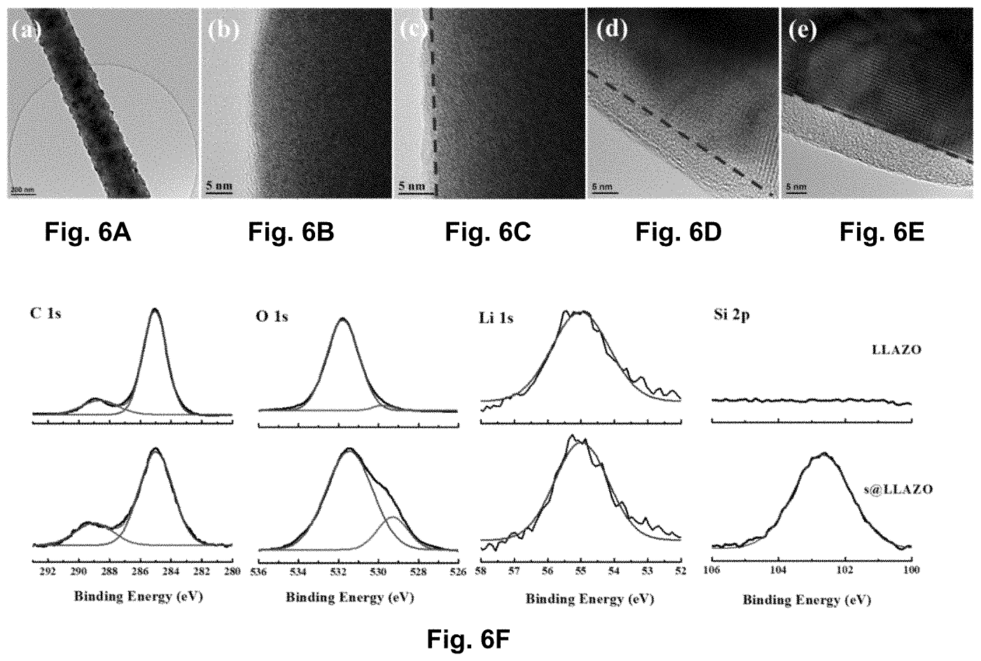

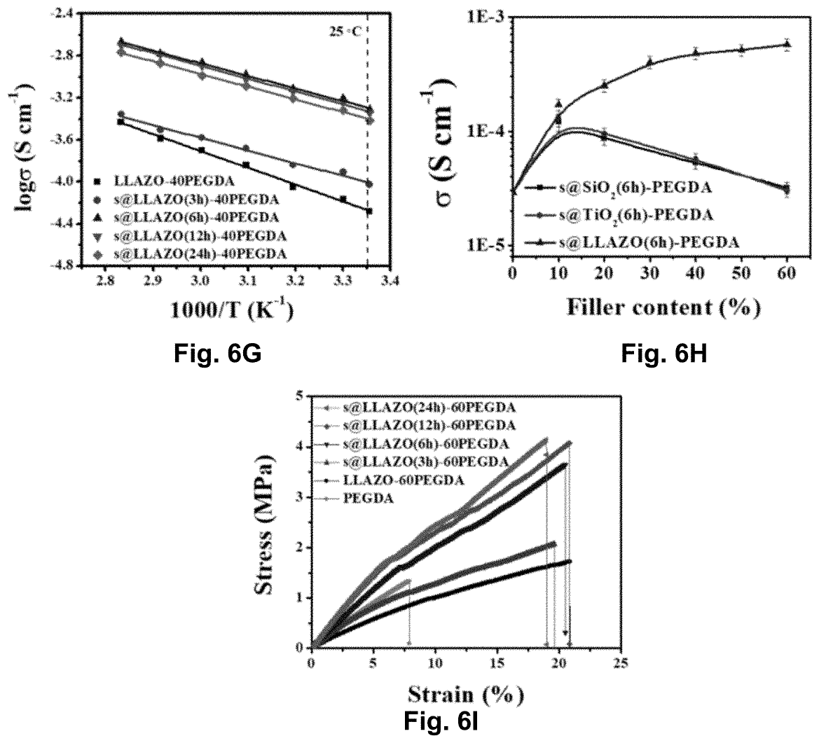

The morphology and crystal structure of calcined LLAZO nanofibers are shown in FIGS. 5A and 5B, respectively. The calcined nanofibers maintained a well-defined 3D fibrous network, and the main peaks in XRD diffraction pattern could be clearly indexed with the cubic LLZO crystal structure. The identical features of LLAZO garnet structure and coating conditions were observed by transmission electron microscopy (TEM). As shown in FIGS. 6A-6E, the silane coating layer was identified as the amorphous layer outside the crystalline structure. For s@LLAZO(6 h), s@LLAZO(12 h), and s@LLAZO(24 h) nanofibers, the coating thicknesses were approximately 2, 5, and 7 nm, respectively. A tiny (<1 nm) amount of silane coating layer was detected for s@LLAZO(3 h) nanofibers due to the short treatment time.

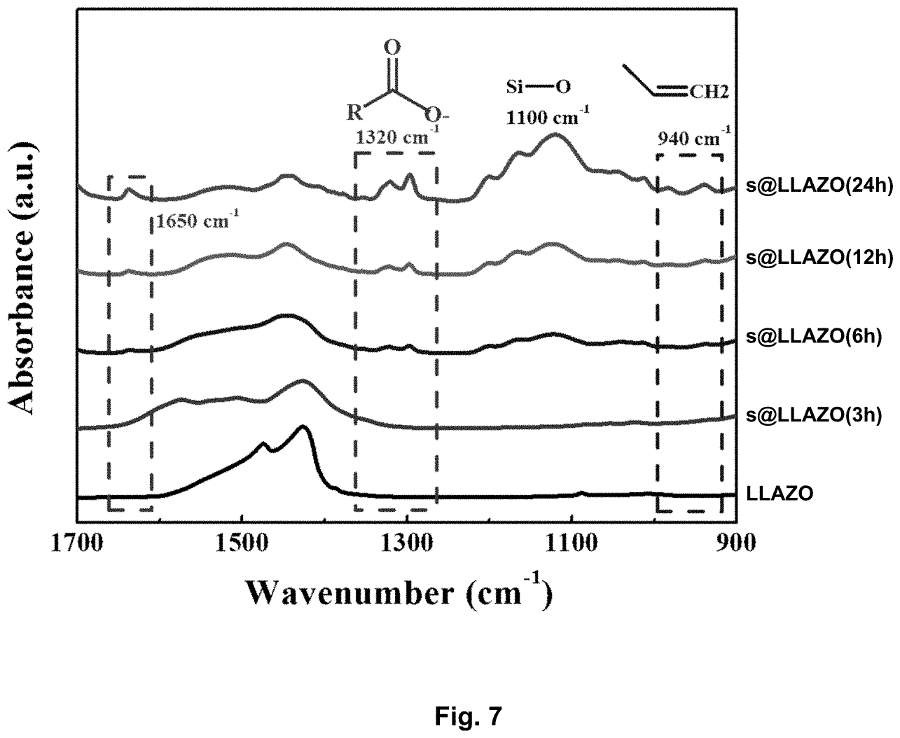

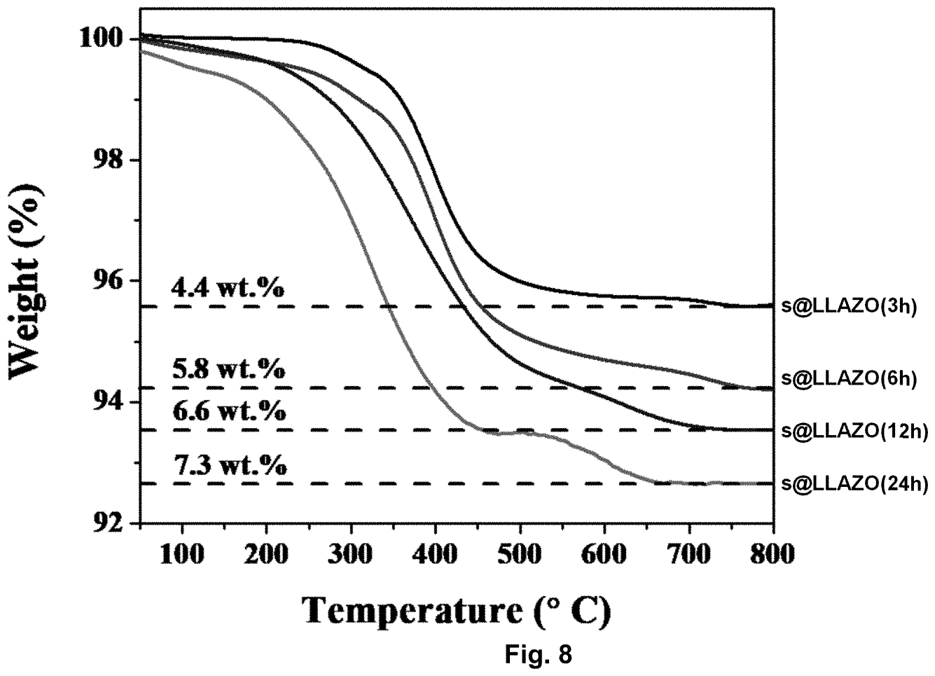

To elucidate the nature of the surface of silane-modified nanofibers, pristine LLAZO and s@LLAZO nanofibers were analyzed using Fourier-transform Infrared Spectroscopy (FTIR) and X-ray photoelectron spectroscopy (XPS). As shown in FIG. 7, the FTIR spectra of s@LLAZO illustrated the appearance of additional absorption peaks after hydrolysis. The main absorption peaks located at 1650, 1320, 1100, and 940 cm⁻¹ were attributed to the stretching vibration of C═O, stretch of COO⁻, stretching vibration of Si—O, and bending vibration of C═C, respectively, corresponding to acrylate, siloxane, and vinyl groups as depicted in FIG. 7. (Refs. 23,24) Those additional main peaks confirmed the presence of chemically bonded silane coating on the surface of LLAZO nanofibers. The weight percentage of silane component in s@LLAZO nanofibers was estimated by thermal gravity analysis (TGA) (FIG. 8). As summarized in Table 1, the approximate silane percentages in s@LLAZO nanofibers were 4.4-7.3 wt. % for 3 to 24 hours of hydrolysis treatment. The XPS spectra of C 1s, O 1s, Li 1s, and Si 2p are shown in FIG. 6F, which further confirmed the surface configuration of s@LLAZO nanofibers. LLAZO and s@LLAZO nanofibers exhibited the same peaks in Li 1s and C 1s XPS spectra, illustrating the major Li—O (Li 1s at 54.7 eV, and O 1s at 529 eV) bonds in LLAZO structure and possible formation of Li₂CO₃ (C 1s at 289.2 eV) on the surface due to reaction with moisture in air. (Refs. 25,26) Additional peaks in O 1s and Si 2p spectra located at 531.5 eV (O 1s) and 102.5 eV (Si 2p) were ascribed to silane molecules on the surface of s@LLAZO nanofibers, which represented Si-0 bonds and further demonstrated the success of applying a coating layer on the LLAZO nanofibers. (Ref. 27) Note that signals from the peaks of La 4d and Zr 3d failed to be detected due to the penetration limitation of XPS.

TABLE 1
Electrochemical and mechanical properties of s@LLAZO-PEGDA CSEs.

| | Silane | Ionic | | | | |
|---|---|---|---|---|---|---|
| | Coating | Conductivity | Activation | Young's | Tensile | |
| | Time | (S/cm) | Energy | Modulus | Strength | Elongation |
| Samples | (h) | (at 25° C.) | (eV) | (MPa) | (MPa) | (%) |
| PEGDA | — | — | — | 18.1 | 1.4 | 7.9 |
| LLAZO-40PEGDA | 0 | 5.2 × 10⁻⁵ | 0.41 | 10.4 | 1.7 | 21.0 |
| s@LLAZO(3 h)-40PEGDA | 3 | 9.4 × 10⁻⁵ | 0.31 | 17.8 | 2.1 | 19.7 |
| s@LLAZO(6 h)-40PEGDA | 6 | 4.9 × 10⁻⁴ | 0.29 | 24.8 | 3.7 | 20.5 |
| s@LLAZO(12 h)-40PEGDA | 12 | 4.6 × 10⁻⁴ | 0.30 | 27.6 | 4.1 | 20.9 |
| s@LLAZO(24 h)-40PEGDA | 24 | 3.9 × 10⁻⁴ | 0.30 | 29.5 | 4.2 | 19.1 |

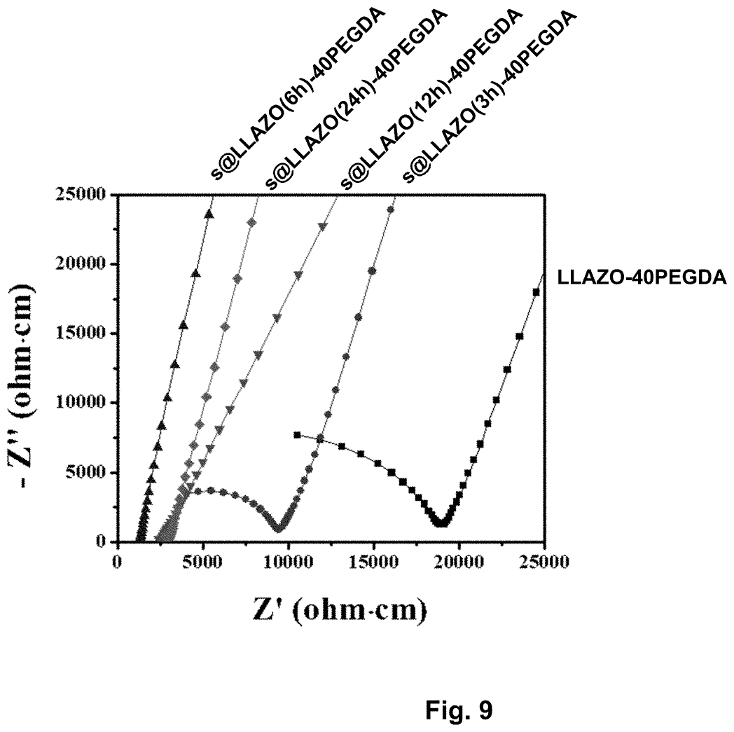

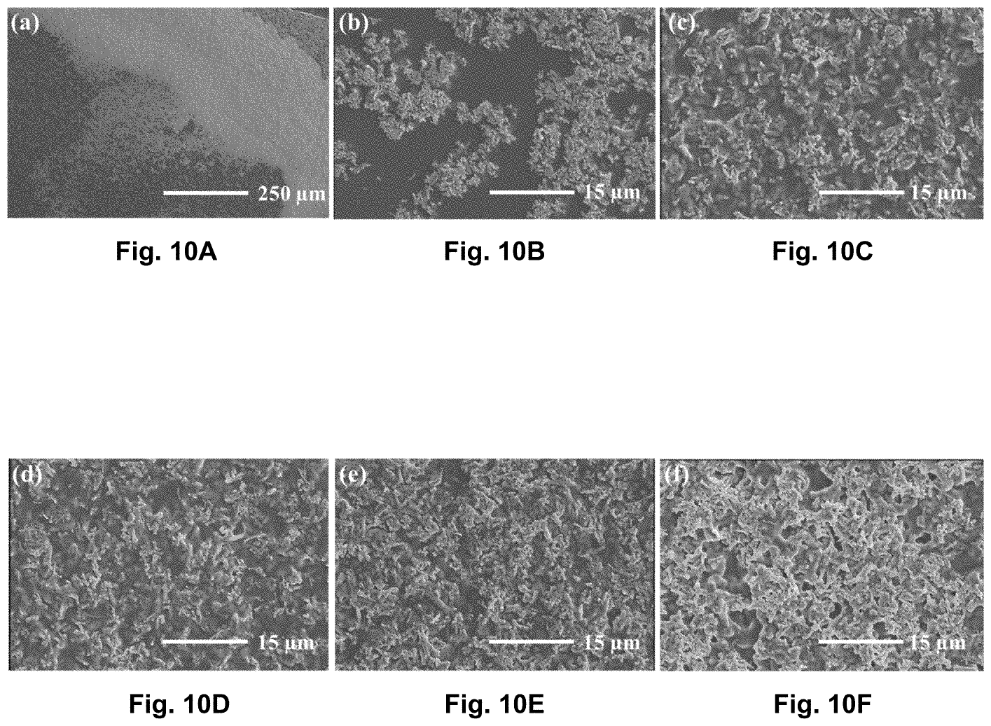

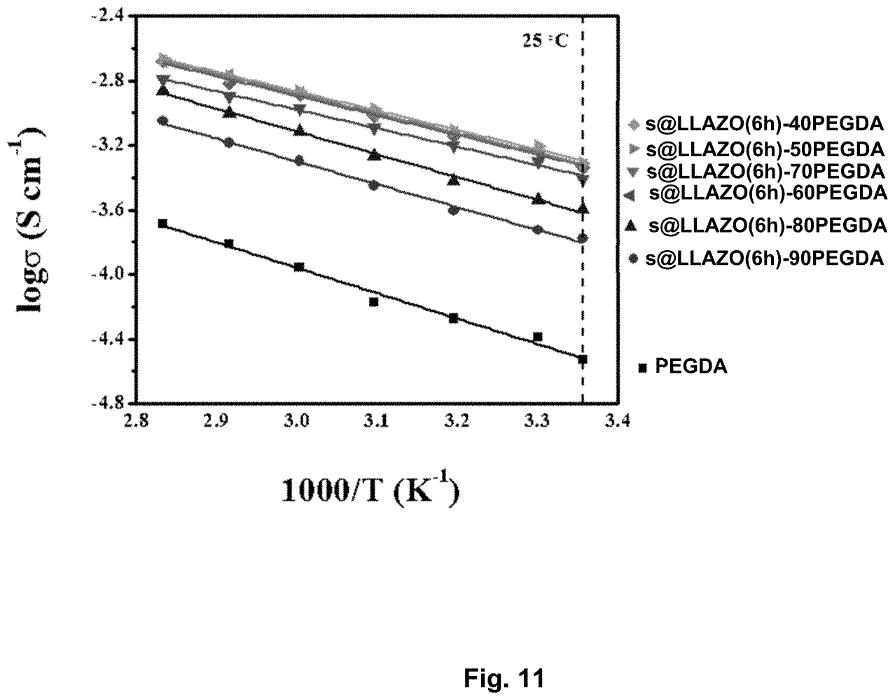

The ionic conductivities of s@LLAZO-PEGDA CSEs were measured using electrochemical impedance spectroscopy (EIS) as illustrated in FIG. 9. As calculated with obtained total resistance, without the silane coating layer, LLAZO-40PEGDA CSE exhibited the lowest ionic conductivity of 5.3×10⁻⁵ S cm⁻¹ at room temperature. The relatively low ionic conductivity was due to the extremely high content of LLAZO nanofibers within the CSE, which led to the agglomeration of fillers and destruction of conducting pathways. In contrast, with the presence of silane coating layers, s@LLAZO-40PEGDA CSEs showed much higher ionic conductivities. The s@LLAZO(6 h)-40PEGDA CSE reached its maximum ionic conductivity of 4.9×10⁻⁴ S cm⁻¹ at room temperature, manifesting the improved Li+conduction within the composite structure with use of silane-modified LLAZO nanofibers. A slight decrease in ionic conductivity was observed with longer coating time (s@LLAZO(24 h)-40PEGDA, 3.9×10⁻⁴ S cm⁻¹), which may have been due to the suppression of surface Li⁺ conduction with a thicker coating. The distribution of Li⁺ conductors in CSEs was further investigated by scanning electron microscope (SEM). As shown in FIG. 10A and 10B, the distribution of untreated LLAZO nanofibers in LLAZO-40PEGDA CSE was not at all uniform. At high filler content, the nanofibers preferred to locate on the periphery of the solid electrolyte membrane, resulting in disturbed Li⁺ pathways. With silane modification, the acrylate groups on s@LLAZO nanofibers were activated along with polymerization, leading to the homogeneous assembly of Li⁺ conductors and polymer in the composite structure (FIG. 10C-10F). It was the well-connected, fast Li⁺ conducting pathways provided by s@LLAZO nanofibers that maximized the Li⁺ conductivities in the introduced CSEs.

FIG. 6G illustrates the temperature dependence of ionic conductivity by Arrhenius plots. All curves obeyed linear behavior with respect to temperature because the cross-linked polymer matrix was fully amorphous and had no phase change with increasing temperature. It was noted that all s@LLAZO-40PEGDA CSEs exhibited lower activation energy (Eₐ) (˜0.30 eV) than LLAZO-40PEGDA (0.41 eV). This difference in Eₐ indicated the different Li⁺ conduction preferences in CSEs with and without silane modification. Interconnected fibrous garnet phase played the dominant role in Li⁺ conduction in s@LLAZO-40PEGDA CSEs. The Li⁺ were mostly conducted by the segmental motion of polymer chains in LLAZO-40PEGDA CSE with untreated LLAZO nanofibers due to the highly aggregated LLAZO phase that blocked Li⁺ conduction. (Refs. 20,28) To better illustrate the percolated structure formed with s@LLAZO nanofibers, ionic conductivities were measured for s@LLAZO-PEGDA CSEs with different nanofiber weight contents. As shown in FIG. 6H and FIG. 11, the ionic conductivities of s@LLAZO(6 h)-PEGDA CSEs continually increased with increasing weight content of nanofibers. The trendline of the curve up to 60 wt. % of filler content fit well with the percolation models derived by Yu. (Refs. 20,21) This indicated the well-established Li⁺ conducting network within the CSE. Remarkably, the silane coating layer totally eliminated the agglomeration of fillers and enhanced the conductivity with a higher degree of percolated framework. Due to the limitation of the created interphase in the composite structure, the ionic conductivities did not change from 40 wt. % (4.7×10⁻⁴S cm⁻¹) to 60 wt. % (4.9×10⁻⁴S cm⁻¹) s@LLAZO nanofibers. Based on the criteria of flexibility and Li wettability of the solid electrolyte, s@LLAZO(6 h)-60PEGDA was regarded as the optimum filler concentration.

To investigate the effects of silane coating on conductors other than Li⁺, non-Li⁺ conductors (SiO₂, TiO₂ nanoparticles) were prepared with the same experimental and thefiller effect on the resultant conductivities was measured (FIG. 6H). The conductivities of CSEs with s@SiO₂(6 h) and s@TiO₂(6 h) nanoparticles showed similar trends to the s@LLAZO(6 h)-90PEGDA at filler content of 10 wt. %. This indicated that the addition of inorganic fillers at this lower concentration enhanced the motion of polymer segments and facilitated the Li+conduction due to increased amorphization of polymer chains. However, after increasing filler content beyond 10 wt. %, the ionic conductivities of s@SiO₂(6 h)-PEGDA and s@TiO₂(6 h)-PEGDA CSEs dramatically decreased because a high content of non-Li⁺-conductors led to more discontinuous and blocked Li⁺ conductive channels in the polymer and resultant composite structure. In contrast, a high content of Li⁺-conductor nanofibers with a well-percolated network provided a fast and continuous Li⁺ pathway. This significant difference in conductivities between the Li⁺ vs. the non-Li⁺ conductors confirmed that the active (s@LLAZO) filler provided significant contribution for Li⁺ conduction in s@LLAZO(6 h)-PEGDA CSEs. To elucidate he exact mechanism for the superior conductivities, further study is still needed.

In addition to conductivity, high mechanical strength is desirable to control the growth of Li dendrites in solid-state Li-metal batteries. (Refs. 4,29) FIG. 6I characterizes the Young's modulus, tensile strength, and elongation of CSEs, and the corresponding values are summarized in Table 1. The pristine PEGDA polymer electrolyte showed a Young's modulus of 18.1 MPa, tensile strength of 1.36 MPa, and maximum elongation of 7.9%. With the addition of LLAZO nanofibers, LLAZO-60PEGDA showed increased elongation (21%) and tensile strength (1.74 MPa) but reduced Young's modulus (10.4 MPa) due to the plasticized effect. When the polymer was directly grafted on s@LLAZO nanofibers through the silane coupling agent, the tensile strength and Young's modulus were dramatically increased to 24.8 MPa and 3.7 MPa for s@LLAZO-60PEGDA CSE, respectively.

3. Advanced Electrochemical Performance of s@LLAZO-PEGDA Composite Solid Electrolytes

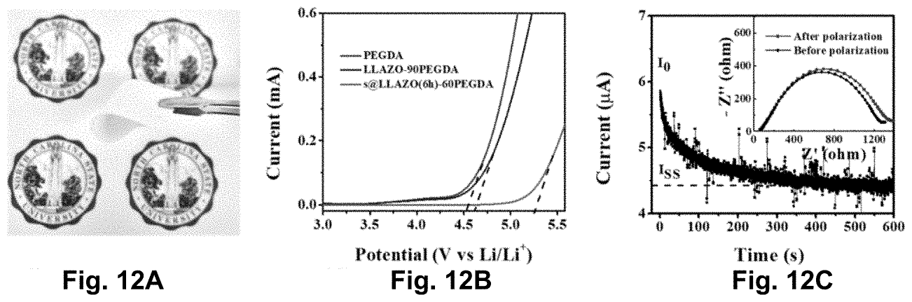

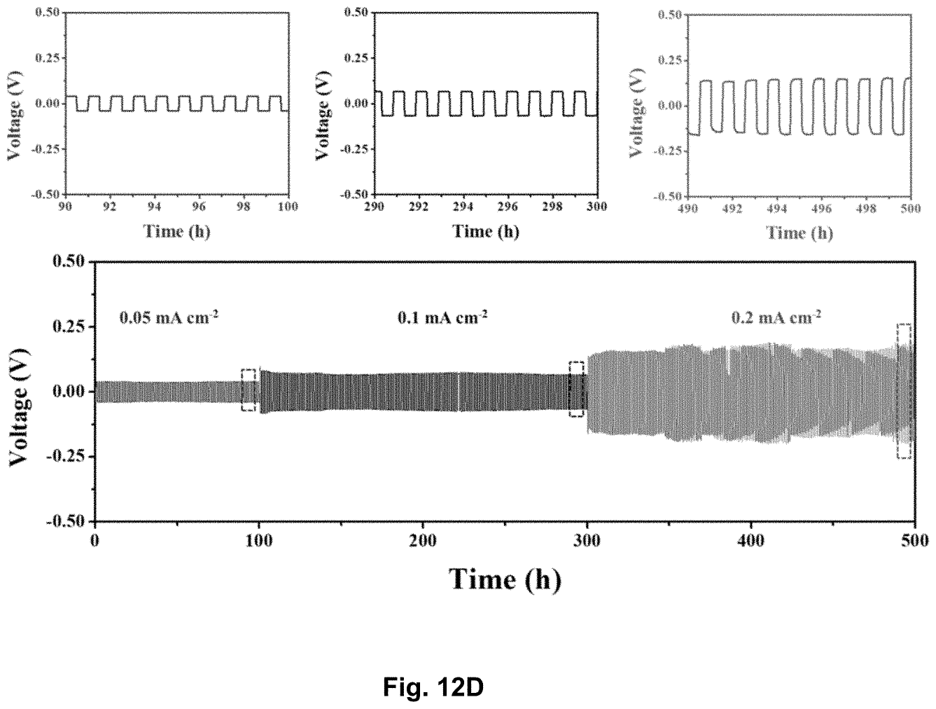

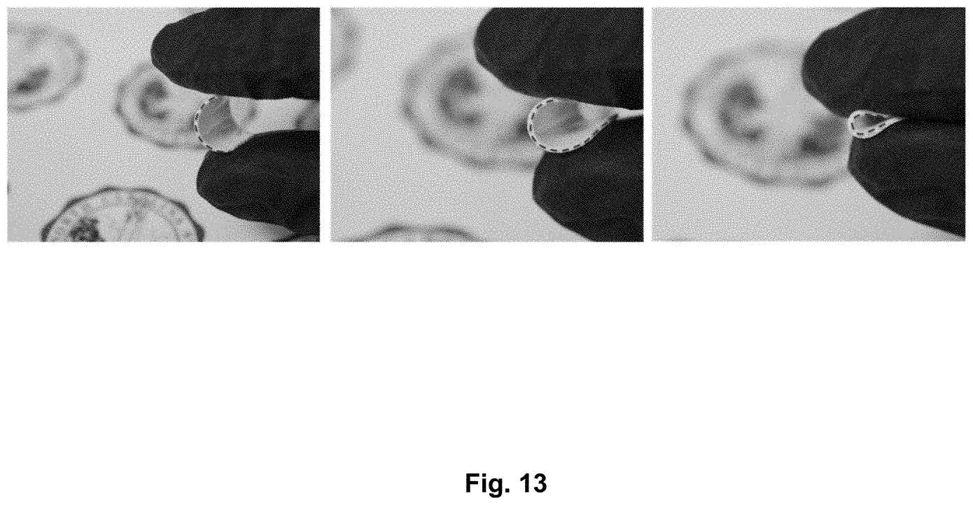

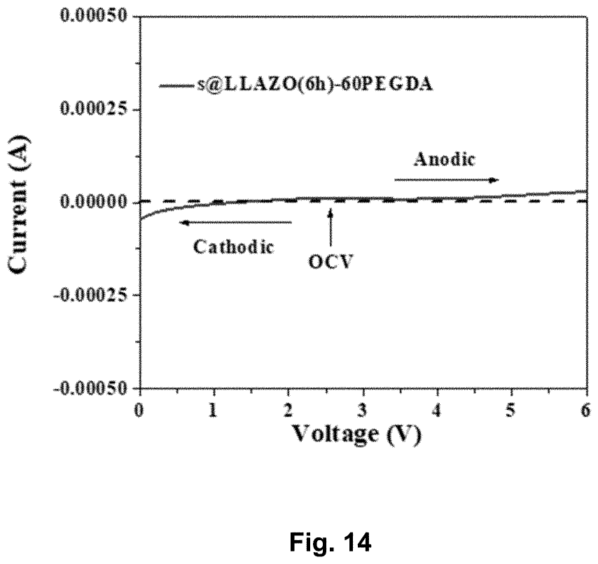

The structural and chemical advantages of the silane coating make it ideal for reinforcing the mechanical and electrochemical properties of composite polymer electrolytes. FIG. 12A shows a digital image of the as-prepared s@LLAZO(6 h)-60PEGDA solid electrolyte membrane. The entire flexible membrane was able to be twisted, bent, and rolled up without cracking (FIG. 13), suggesting that s@LLAZO(6 h)-60PEGDA had sufficient mechanical flexibility to be in solid-state Li batteries. In previous works with conventional CSEs, to maximize the ionic conductivity, the content of inorganic fillers was controlled below 15 wt. % to avoid the particulate agglomeration. Therefore, the resultant CSEs often exhibited low lithium transference number (t_{Li+}) and poor electrochemical stability, which in turn led to insufficient cycling stability in solid-state Li batteries. In addition, the oxidation of PEO-based polymer occurred at low voltage (˜4.2 V), preventing the development of high-power Li-metal batteries. (Ref. 30) As illustrated in FIG. 12B, the anodic current onset is linked to electrochemically oxidized decomposition. The bare PEGDA and LLAZO-90PEGDA solid electrolytes exhibited similar anodic stability because of the high content of PEO cross-linked polymer. Nevertheless, owing to the excellent electrochemical stability of the inorganic Li⁺ conductor, the oxidized decomposition onset started at 5.3 V for s@LLAZO-60PEGDA CSE, which greatly extended the overall stability window (FIG. 14). Moreover, FIG. 12C gives the typical DC polarization curve of Li|s@LLAZO(6 h)-60PEGDA|Li symmetric cells. The Lithium transference number (t_{Li+}) was calculated by Bruce's equation with the obtained initial current (l₀), steady-state current (lₛₛ), and the corresponding impedances at two states. (Ref. 31) The s@LLAZO(6 h)-60PEGDA CSE exhibited a t_{Li+} as high as 0.62 due to the improved utilization of inorganic Li⁺ conductors. In contrast, t_{Li+} was 0.2 and 0.25 for bare PEGDA and LLAZO-90PEGDA solid electrolytes, respectively. Significant improvement in t_{Li+} of s@LLAZO(6 h)-60PEGDA CSE was attributed to the strong Lewis acid-base interaction between s@LLAZO nanofibers and Li salts, which restricted the delocalized anions and promoted free Li⁺ mobility. Benefiting from the silane modification, the introduced CSE exhibited superior electrochemical properties due to the well-percolated LLAZO network within the composite structure. The controlled formation of organic-inorganic framework greatly enhanced electrochemical stability and t_{Li+}, leading to improved safety and stability in all-solid-state Li batteries.

Long-term lithium cycling stability and compatibility of s@LLAZO(6 h)-60PEGDA was evaluated by galvanostatic striping (0.5 h) and plating (0.5 h) measurement. As shown in FIG. 12D, stable DC cycling as a function of current density was achieved over the entire test period. The symmetric cell exhibited low overpotentials of 35, 69, and 159 mV at current densities of 0.05, 0.1, and 0.2 mA/cm², respectively. The cells kept a smooth Li striping/plating process for over 500 h, indicating the stable interfacial properties between Li metal and the solid electrolyte membrane. (Refs. 28,32) Additionally, the low and stable cycling overpotentials demonstrated the high ionic conductivity and excellent stability against Li metal.

4. High Performance of All-Solid-State Li-Metal Batteries

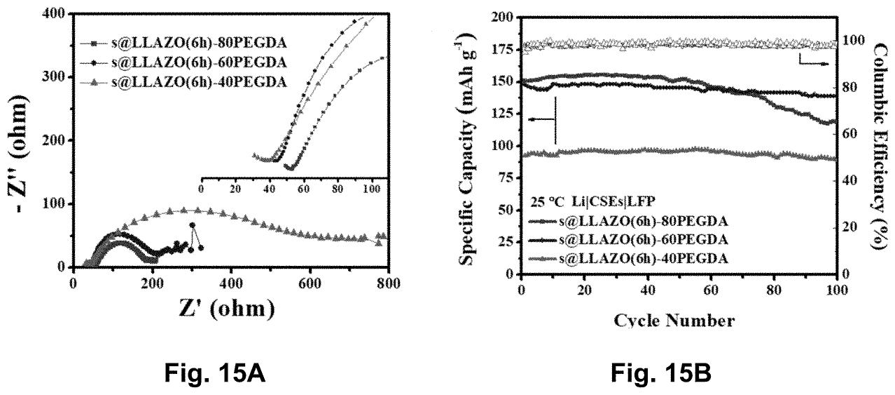

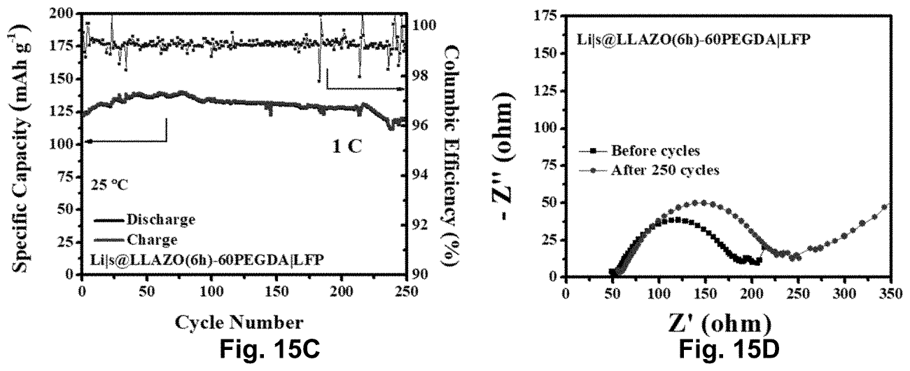

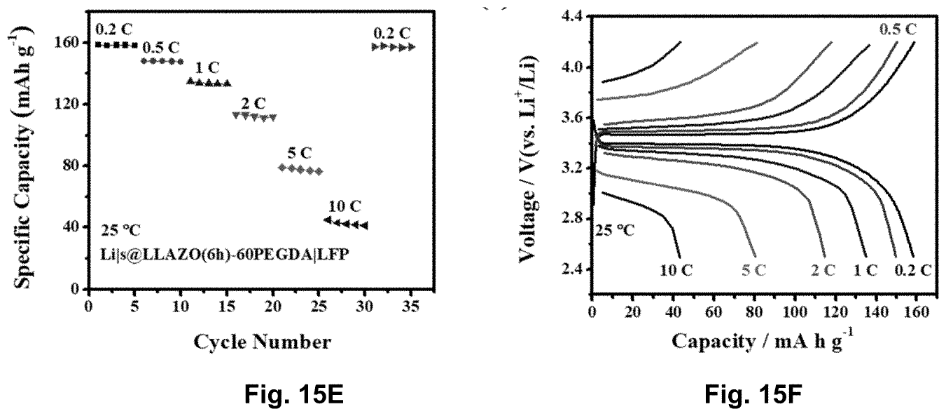

All-solid-state batteries were assembled with the s@LLAZO(6 h)-PEGDA CSEs as electrolyte, pure Li metal as anode and LiFePO₄ as cathode. Three CSEs with different s@LLAZO nanofiber contents were studied to establish the relationship between cycling performance and filler content. FIG. 15A shows the EIS profiles of Li|LiFePO₄ cells with three different CSEs, where the partial semicircle at the high-frequency range was attributed to the bulk impedance (Rb) of solid electrolyte and the large semicircle in the medium frequency range was attributed to a the charge transfer (Rct) and diffusion processes at the electrolyte/electrode interface. (Ref. 33) All three cells demonstrated similar bulk resistances (Rb) in the range of 40-50 Ω, which indicated similar ionic conductivities of the three solid electrolytes. However, compared to s@LLAZO(6 h)-80PEG DA and s@LLAZO(6 h)-60PEGDA solid electrolytes, s@LLAZO(6 h)-40PEGDA showed much higher Rct (˜600 Ω), indicating that it had higher interfacial resistance and poorer contact with the electrode. The corresponding cycling performance with the three CSEs is illustrated in FIG. 15B. At a current density of 0.5C, the cell with s@LLAZO(6 h)-40PEGDA delivered the lowest initial capacity of 93 mAh g⁻¹ due to high internal resistance attributed to poor contact with the Li metal. Retained capacities of 153 and 147 mAh g⁻¹ were obtained for the cells with s@LLAZO(6 h)-80PEGDA and s@LLAZO(6 h)-60PEGDA, respectively. Owing to its high content of inorganic filler, s@LLAZO(6 h)-40PEGDA demonstrated the best cycling stability with a high capacity retention of 98% after 100 cycles. Clearly, the increasing content of s@LLAZO nanofibers provided more stable cycling due to enhanced electrochemical stability and increased t_{Li+}, resulting in decreased mobility of TFSI⁻ anions and alleviation of the internal concentration gradient of accumulated anions. In overall consideration, the cell assembled with s@LLAZO(6 h)-60PEGDA showed optimum cycling performance with relatively high capacity of 147 mAh g⁻¹ and relatively high capacity retention of 95% after 100 cycles. We anticipate that the cells with s@LLAZO(6 h)-40PEGDA would deliver even better cycling performance with appropriate interfacial modification between Li metal and solid electrolyte.

To further demonstrate the cycling stability at higher current densities, the cell with s@LLAZO(6 h)-60PEGDA CSE was galvanostatically cycled at a current density of 10. As shown in FIG. 15C, the cell retained a capacity of over 115 mAh g⁻¹ up to 250 cycles, resulting in 89% of capacity retention. The Coulombic efficiency remained high at 99%, which indicated good reversibility of the redox reactions processed in the battery system. FIG. 15D demonstrates the EIS results of the solid-state Li|LiFePO₄ cell after long cycles. The nearly invariable values of bulk impedance (Rb) indicated excellent stability of s@LLAZO(6 h)-60PEGDA CSE. The mild increase in charge transfer resistance (Rct) was attributed to the slight formation of a passivation layer on the electrode surface and irregular deposition of Li⁺. Along with the excellent cycling stability, solid-state Li|s@LLAZO(6 h)-60PEGDA|LiFePO₄ cells also showed remarkable rate capability (FIG. 15E). Discharge capacities of 158, 147, 135, 113, and 78 mAh g⁻¹ were obtained at varied rates of 0.2, 0.5, 1, 2, and 5 C, respectively. Even at a high current density of 10 C, the cell could still deliver a capacity of 44 mAh g⁻¹. After applying cycles at higher current densities, the discharge capacity increased again to as high as 158 mAh g⁻¹ when the current density was reduced to 0.2 C. Such a high C-rate performance is remarkable for all-solid-state batteries operating at room temperature. This was mainly attributed to the well-established percolated LLAZO network that provided fast and non-tortuous Li+conduction in the composite structure. FIG. 15F shows typical charge-discharge curves at different C rates. Distinct plateaus at 3.49 and 3.36 V were shown in the charging and discharging curves at low current density (0.2, 0.5, and 1 C), which were equivalent to the Li⁺ extraction and insertion to LiFePO₄ at the voltage region for the Fe³⁺/Fe²⁺, respectively. (Refs. 34,35) The excellent rate performance in all-solid-state Li-ion batteries again validated the superior electrochemical properties of s@LLAZO(6 h)-60PEGDA CSEs and critical influence of the silane coating layer.

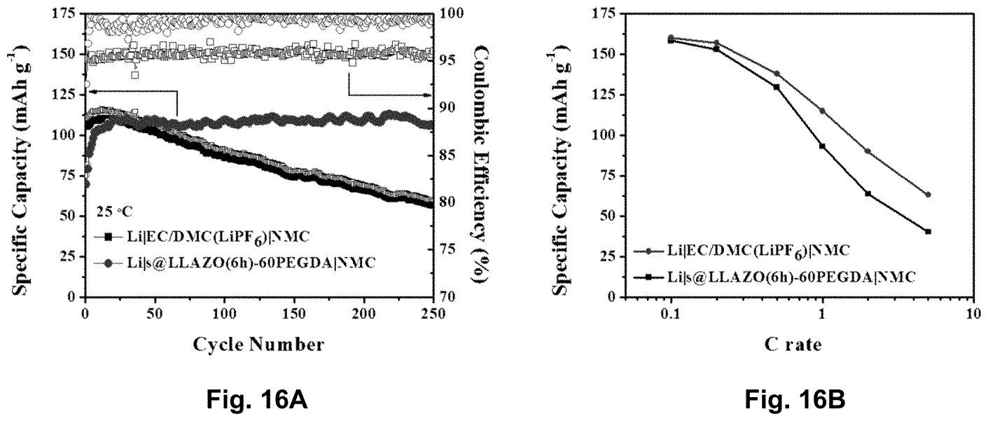

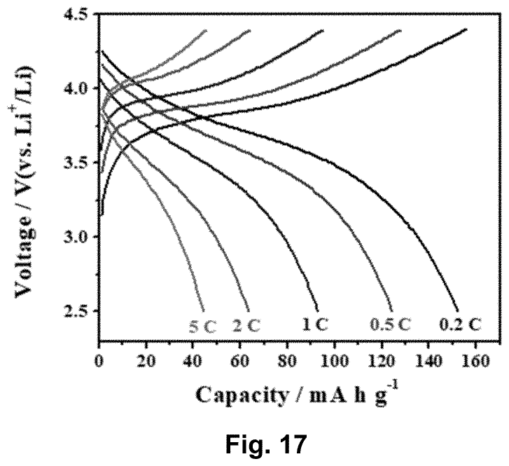

To prove the utility of our newly-designed garnet-rich solid electrolyte, its successful application along with a high-voltage cathode (Li[Ni_{1/3}Mn_{1/3}Co_{1/3}]O₂) is critical. As a promising cathode, NMC has a higher discharge potential (˜3.9 V) and higher theoretical capacity (200 mAh g⁻¹) as compared to a Li⁺/Li structure. However, the reversibly accessible capacity depends highly on the upper cut-off voltage (>4.5 V vs. Li⁺/Li).General Li|NMC cells exhibited poor cycle life due to degradation and gas evolution because of the electrolyte's instability at high voltages. (Refs. 36,37,38) As shown in FIG. 16A, rapid capacity fading was observed for NMC cathodes in liquid cells, which was attributed to chemical oxidation of the electrolyte caused by release of reactive oxygen from the delithiated NMC surface at high-voltage cut-off. (Refs. 37,39) In contrast, the cells with garnet-rich CSEs displayed superior cycling stability owing to an enlarged oxidation limit (>5.2 V) with a high content of inorganic Li⁺ conductors. Increasing capacity was observed at initial cycles because of the improved surface contact of CSEs with electrodes. In later cycles, the cell stabilized at 110 mAh g⁻¹ after 250 cycles (capacity retention 97%) at 0.5 C at room temperature. Much higher Coulombic efficiency (˜98.9%), compared to liquid cells (˜95.5%), indicated stable redox reactions and effectively controlled electrode degradation. (Ref. 40) Similarly, all-solid-state Li|NMC cell demonstrated high rate capability at room temperature as illustrated in FIG. 16B. Comparable capacities were delivered in solid-state Li|s@LLAZO(6 h)-60PEGDA|NMC cell compared with liquid electrolyte at all tested C rates (0.2-5 C). The stable plateaus and low over-potentials at all C rates (FIG. 17) again indicated the high Li⁺ conductivity and excellent electrochemical stability of the introduced garnet-rich CSEs. The success of the s@LLAZO-PEGDA CSEs along with intercalating cathodes was another step forward in proving their potential. With the s@LLAZO-PEGDA CSEs superior electrochemical properties, we anticipate that they could also be successfully incorporated in a system with conversion cathodes.

5. Conclusions

The Examples demonstrate a novel composite solid electrolyte (CSE) was developed with enriched LLAZO garnet nanofibers. The s@LLAZO nanofibers enabled direct monomer grafting, resulting in a controlled formation of an organic-inorganic network that successfully eliminated the agglomeration effects typically encountered in conventional CSEs with high inorganic filler content. Benefiting from strong coupling between the nanofibers and polymer with high concentration and uniform distribution of s@LLAZO nanofibers in composite structure, the resultant CSEs (s@LLAZO(6 h)-60PEGDA) exhibited high room-temperature ionic conductivity, large lithium transference number, and wide electrochemical stability. Remarkably, all-solid-state Li-metal batteries assembled with the developed CSEs demonstrated stable cycling performance for 250 cycles and extraordinary high rate capability (up to 10 C) at room temperature owing to the maximized utilization of fast Li⁺ conductors (LLAZO) in the composite structure. Moreover, the enlarged electrochemical window of introduced CSEs enabled the stable redox reactions in solid- state NMC cells at high upper cut-off voltage, resulting in a much better cycle life. In short, this novel structural design of CSEs has significant potential in the development of improved functioning all-solid-state Li-metal batteries.

### E. Experimental Materials and Methods

1. Materials

Lithium Nitrate (LiNO₃), Aluminum Nitrate Nonahydrate (Al(NO₃)₃.9H₂O), Zirconium Butoxide solution (Zr(OCH₂CH₂CH₂CH₃)₄, 80 wt. % in ethanol), Lithium Acetate (LiCH₃COO·H₂O), Nickel Acetate (Ni(CH₃COO)₂.H₂O), Manganese Acetate (Mn (CH₃COO)₂.4H₂O), Cobalt Acetate (Co(CH₃COO)₂.4H₂O), N,N-Dimethylformamide (DMF), N-Methyl-2-pyrrolidone (NMP), Acetic Acid (CH₃CO₂H), Polyvinylpyrrolidone (PVP, Mw=1,300,000), Bis(trifluoromethane)sulfonimide lithium salts (LiTFSI), 3-(trimethoxysilyl)propyl methacrylate (silane), 2,2′-Azobis(2-methylpropionitrile) (AlBN), and Poly(ethylene glycol) diacrylate (PEGDA, Mw=575) were purchased from Sigma-Aldrich. Lanthanum Nitrate Hexahydrate (La(NO₃)₃.6H₂O) were purchased from Alfa-Aesar. All chemicals were used as received without further purification.

2. Fabrication of Li_{6.28}La₃Al_{0.24}Zr₂O₁₂ (LLAZO) Nanofibers

The electrospinning precursor solution was first prepared by dissolving stoichiometric amounts of 9.42 mmol of LiNO₃, 4.5 mmol of La(NO₃)₃.6H₂O, 0.36 mmol of Al(NO₃)₃.9H₂O, and 3 mmol of Zr(OCH₂CH₂CH₂CH₃)₄ in 20 ml of DMF with 15 vol % acetic acid. Excess LiNO₃ (15 wt. %) was added to compensate for lithium loss during the subsequent calcination procedure. After stirring for 30 min, 2 g of PVP (Mw=1,300,000) was added. The solution was mechanically stirred overnight and then sonicated for 10 min before use to eliminate the air bubbles. The asspun fibers were later calcined at 850° C. for 2 h to obtain LLAZO nanofibers.

3. Fabrication of Silane-Modified Li_{6.28}La₃Al_{0.24}Zr₂O₁₂ (s@LLAZO) Nanofibers

For a typical synthesis of s@LLAZO nanofibers, the silane precursor solution was first prepared, which consisted of 2.5 vol % 3-(trimethoxysilyl)propyl methacrylate, 2.5 vol % acetic acid, 5 vol % water, and 90 vol % ethanol. The precursor solution was left for 1 h to stabilize the pH value and to activate alkoxy groups to silanols (≡Si—OH). 600 mg of LLAZO nanofibers were then added into 40 ml of precursor solution and kept stirring for 3 h, 6 h, 12 h, and 24 h at 70° C. After silanization, s@LLAZO nanofibers were collected by centrifugation and washed three times with ethanol.

4. Fabrication of s@LLAZO-PEGDA Composite Solid Electrolytes

The composite solid electrolytes were fabricated by first dispersing the s@LLAZO nanofibers in N-Methyl-2-pyrrolidone (NMP), followed with sonication for 5 min to get uniform dispersion. The initiators (AIBN), monomers (PEGDA, Mw=575), and lithium salts (LiTFSI) were then added into the solution. For cross-linked polymer, the amount of initiator was controlled 0.1 wt. % based on the total weight of monomers, and the amount of lithium salts was controlled at [EO]/[Li⁺]=12. The prepolymer solution was then casted on the glass substrate and cross-linked into thin films at 80° C. for 30 min in argon-filled glove box. The resultant composite solid electrolytes were denoted as s@LLAZO(x)-nPEGDA, where x represented the silane treatment time and n the weight content of PEGDA polymer.

5. Synthesis of Li[Ni_{1/3}Mn_{1/3}Co_{1/3}]O₂ (NMC) Nanoparticles

A simple sol-gel method, followed by high-temperature calcination process, is used to prepare NMC nanoparticles. An aqueous solution was made by dissolving 10 mmol LiCH₃COO.H₂O, 3.3 mmol Ni(CH₃COO)₂.4H₂O, 3.3 mmol Mn(CH₃COO)₂.4H₂O, and 3.3 mmol Co(CH₃COO)₂.4H₂O in 18 ml deionized water. Citric acid solution (1M) was added to form chemical bonds with metal ions and a sol-gel precursor according to the metal ions to citric acid ratio of 1:1.6. The reactant solution was heated to 90° C. for 4 hours with magnetic stirring and then kept in 80° C. overnight to evaporate the solvent, followed by calcinated in 450° C. for 1 hour to remove the acetate groups. After being slightly grounded, the intermediate powder was further calcinated in 900° C. for 12 hours to obtain the NMC nanoparticles.

### F. SUPPORTING INFORMATION

1. Characterization Methods

Fourier transform-infrared spectroscopy (FT-IR, Thermo Scientific™ Nicolet™ iS™10) was used to identify the functional groups of LLAZO and s@LLAZO nanofibers. The IR spectra were collected under absorbance mode from 425 to 4000 cm⁻¹ for 32 scans and resolution of 4 cm⁻¹. X-ray photoelectron spectroscopy (XPS, SPECS FlexMod, Germany) was used to execute the surface elemental analysis and identify the surface functional groups of LLAZO and s@LLAZO nanofibers. Thermo-gravimetric analysis (TGA) was conducted in a Perkin Elmer Pyris 1 with a heating rate of 20° C. min-1 under air atmosphere to estimate the weight percentages of silane in s@LLAZO nanofibers. X-ray diffraction (XRD) was used to identify the crystal structures of fabricated LLAZO nanofibers using a Rigaku D/Max 2400 (Japan) with Cu Ka radiation (λ=1.5418 Å) in a 2-Theta angle range from 10° to 70°. The morphologies of LLAZO nanofibers, LLAZO-PEGDA CSE, and s@LLAZO-PEGDA CSEs were characterized by field-emission scanning electron microscopy (FE-SEM, FEI Verios 460L, USA) and high-resolution transmission electron microscopy (HR-TEM, JEOL-2010F, Japan). The mechanical properties CSE membranes (10×50 mm) were obtained using a universal testing machine (MTS Criterion) (Loading: 100 N; cross-head speed: 0.1 mm/s).

2. Electrochemical Performance Tests

The total lithium-ion conductivity was characterized by electrochemical impedance spectroscopy (Garmy Reference 600 device) over a frequency range of 0.1 Hz to 1 MHz. The solid electrolyte membranes were sandwiched between two stainless steel blocking electrodes. On the Nyquist plot, the intercepts of extended semicircles with real axis represent the bulk resistance of SE, and the ionic conductivity was calculated by the following equation (1):

$$σ = \frac{1}{R} \frac{t}{A} \qquad ( 1 )$$

where R is bulk resistance, t is sample thickness, and A is sample area. Activation energy (Eₐ) was calculated by the Arrhenius equation (2):

σ=Aexp (−Eₐ/RT) (2)

with Arrhenius plot of ionic conductivities. Li transference numbers (t_{Li+}) were determined by the chronoamperometry test on symmetric lithium cells with an applied DC voltage of 10 mV. EIS was also performed both before and after the polarization with the frequency ranging from 1 MHz to 1 Hz. The t_{Li+} value was calculated by Bruce's equation (3):

$${t}_{L {i}^{+}} = \frac{{I}_{s s} ( ΔV - {I}_{0} {R}_{0} )}{{I}_{0} ( ΔV - {I}_{s s} {R}_{ss} )} \qquad ( 3 )$$

where ΔV is the polarization voltage, I₀ is the initial current, I_{SS} is the steady state current, R₀ is the initial total resistance, and R_{SS} is the steady state total resistance. Liner sweep voltammetry (LSV) was carried out to test the electrochemical stability of CSEs at a scan rate of 10 mVs⁻¹. Galvanostatic cycling of symmetric Li cell was conducted to evaluate the structural stability of solid electrolytes and mimic a charging and discharging operation in lithium metal batteries. All cells were cycled at current densities of 0.05, 0.1, 0.2 mA cm⁻² for 30 min at room temperature. LiILiFePO₄ coin cells were assembled in an argon-filled glove box with obtained s@LLAZO(6 h)-60PEGDA CSE. To prepare the cathode, a slurry of LiFePO₄ or Li[Ni_{1/3}Mn_{1/3}Co_{1/3}]O₂, oligomer solution (poly(ethylene glycol) dimethyl ether, LiTFSI with [EO]/[Li⁺]=12), carbon black (C65, TIMCAL Graphite & Carbon Ltd.), and polyvinylidene fluoride (PVDF) binder was mixed at a weight ratio of 7:1:1:1. The mixture slurry was coated on Al foil by using proper content of NMP as the solvent with a controlled thickness of 35-45 μm. The coated cathode was dried at 80° C. under vacuum for 48 h. The loading of active material in composite cathode was controlled at 1.5 mg cm⁻². Solid electrolyte membranes were directly polymerized on the cathode by casting certain amounts of prepolymer solution (s@LLAZO, PEGDA, LiTFSI, AIBN), followed by thermal polymerization at 80° C. under an Argon environment for 30 min. The all-solid-state LiILiFePO₄ cells were then prepared in an Argon-filled glovebox by stacking Li foil on the composite solid electrolyte. The cycling performance of all-solid-state LiFePO₄ cells was tested by Arbin battery tester in a potential range of 2.5 V to 4.2 V.

### G. REFERENCES

References are cited herein throughout using the format of reference number(s) enclosed by parentheses corresponding to one or more of the following numbered references. For example, citation of references numbers 1 and 2 immediately herein below would be indicated in the disclosure as (Refs. 1 and 2). These references are incorporated by reference in their entirety.
1. Armand M, Tarascon J M. Building better batteries. Nature. 451 652-657 (2008).
2. Xu W, Wang J, Ding F, Chen X, et al. Lithium metal anodes for rechargeable batteries. Energy Environ Sci. 7 513-537 (2014).
3. Bates J, Dudney N, Neudecker B, Ueda A, et al. Thin-film lithium and lithium-ion batteries. Solid State Ionics. 135 33-45 (2000).
4. Sun C, Liu J, Gong Y, Wilkinson D P, et al. Recent advances in all-solid-state rechargeable lithium batteries. Nano Energy. 33 363-386 (2017).
5. Yue L P, Ma J, Zhang J J, Zhao J W, et al. All solid-state polymer electrolytes for high-performance lithium ion batteries. Energy Storage Mater. 5 139-164 (2016).
6. Fan L, Wei S, Li S, Li Q, et al. Recent progress of the solid-state electrolytes for high-energy metal-based batteries. Adv Energy Mater. 8 1702657 (2018).
Wang X, Lu X, Liu B, Chen D, et al. Flexible Energy-Storage Devices: Design Consideration and Recent Progress. Adv Mater. 26 4763-4782 (2014).
8. Fenton D. Complexes of alkali metal ions with poly (ethylene oxide). Polymer. 14 589 (1973).
9. Golodnitsky D, Strauss E, Peled E, Greenbaum S. on order and disorder in polymer electrolytes. J Electrochem Soc. 162 A2551-A2566 (2015).
10. Dias F B, Plomp L, Veldhuis J B. Trends in polymer electrolytes for secondary lithium batteries. J Power Sources. 88 169-191 (2000).
11. Quartarone E, Mustarelli P. Electrolytes for solid-state lithium rechargeable batteries: recent advances and perspectives. Chem Soc Rev. 40 2525-2540 (2011).
12. Niitani T, Shimada M, Kawamura K, Dokko K, et al. Synthesis of Li+ ion conductive PEO-PSt block copolymer electrolyte with microphase separation structure. Electrochem Solid-State Lett. 8 A385-A388 (2005).
13. Rosso M, Brissot C, Teyssot A, Dollé M, et al. Dendrite short-circuit and fuse effect on Li/polymer/Li cells. Electrochim Acta. 51 5334-5340 (2006).
14. Thangadurai V, Narayanan S, Pinzaru D. Garnet-type solid-state fast Li ion conductors for Li batteries: critical review. Chem Soc Rev. 43 4714-4727 (2014).
15. Kamaya N, Homma K, Yamakawa Y, Hirayama M, et al. A lithium superionic conductor. Nature materials. 10 682 (2011).
16. Murugan R, Thangadurai V, Weppner W. Fast lithium ion conduction in garnet—type Li7La3Zr2O12. Angew Chem Int Ed. 46 7778-7781 (2007).
17. Ramakumar S, Deviannapoorani C, Dhivya L, Shankar LS, et al. Lithium garnets: synthesis, structure, Li+conductivity, Li+dynamics and applications. Prog Mater Sci. 88 325-411 (2017).
18. Zhu P, Yan C, Dirican M, Zhu J, et al. Li 0.33 La 0.557 TiO 3 ceramic nanofiber-enhanced polyethylene oxide-based composite polymer electrolytes for all-solid-state lithium batteries. J Mater Chem A. 6 4279-4285 (2018).
19. Fu K, Gong Y H, Dai J Q, Gong A, et al. Flexible, solid-state, ion-conducting membrane with 3D garnet nanofiber networks for lithium batteries. Proc Natl Acad Sci U S A. 113 7094-7099 (2016).
20. Bae J, Li Y, Zhang J, Zhou X, et al. A 3D Nanostructured Hydrogel-Framework-Derived High-Performance Composite Polymer Lithium-Ion Electrolyte. Angew Chem Int Ed Engl. 57 2096-2100 (2018).
21. Wang W, Yi E, Fici A J, Laine R M, et al. Lithium ion conducting poly (ethylene oxide)-based solid electrolytes containing active or passive ceramic nanoparticles. J Phys Chem C. 121 2563-2573 (2017).
22. Dirican M, Yan C, Zhu P, Zhang X. Composite solid electrolytes for all-solid-state lithium batteries. Mater Sci Eng R Rep. 136 27-46 (2019).
23. Hu J, Wang W, Peng H, Guo M, et al. Flexible organic—inorganic hybrid solid electrolytes formed via thiol—acrylate photopolymerization. Macromolecules. 50 1970-1980 (2017).
24. Le H T, Ngo D T, Kalubarme R S, Cao G, et al. Composite Gel Polymer Electrolyte Based on Poly (vinylidene fluoride-hexafluoropropylene)(PVDF-HFP) with Modified Aluminum-Doped Lithium Lanthanum Titanate (A-LLTO) for High-Performance Lithium Rechargeable Batteries. ACS Appl Mater Interfaces. 8 20710-20719 (2016).
25. Im C, Park D, Kim H, Lee J. Al-incorporation into Li7La3Zr2O12 solid electrolyte keeping stabilized cubic phase for all-solid-state Li batteries. J Energy Chem. 27 1501-1508 (2018).
26. Xia W, Xu B, Duan H, Guo Y, et al. Ionic conductivity and air stability of Al-doped Li7La3Zr2O12 sintered in alumina and Pt crucibles. ACS Appl Mater Interfaces. 8 5335-5342 (2016).
27. Dietrich P M, Glamsch S, Ehlert C, Lippitz A, et al. Synchrotron-radiation XPS analysis of ultra-thin silane films: Specifying the organic silicon. Appl Surf Sci. 363 406-411 (2016).
28. Gong Y, Fu K, Xu S, Dai J, et al. Lithium-ion conductive ceramic textile: A new architecture for flexible solid-state lithium metal batteries. Mater Today. (2018).
29. Zhang X, Liu T, Zhang S, Huang X, et al. Synergistic coupling between Li6. 75La3Zr1. 75Ta0. 25O12 and poly (vinylidene fluoride) induces high ionic conductivity, mechanical strength, and thermal stability of solid composite electrolytes. J Am Chem Soc. 139 13779-13785 (2017).
30. Kim Y H, Cheruvally G, Choi J W, Ahn J H, et al. Electrochemical Properties of PEO—Based Polymer Electrolytes Blended with Different Room Temperature Ionic Liquids. Macromolecular Symposia; 2007: Wiley Online Library; 2007. p. 183-189.
31. Bruce P G, Vincent C A. Steady state current flow in solid binary electrolyte cells. Journal of electroanalytical chemistry and interfacial electrochemistry. 225 1-17 (1987).
32. Zhang J, Zhao N, Zhang M, Li Y, et al. Flexible and ion-conducting membrane electrolytes for solid-state lithium batteries: dispersion of garnet nanoparticles in insulating polyethylene oxide. Nano Energy. 28 447-454 (2016).
33. Kotobuki M, Munakata H, Kanamura K, Sato Y, et al. Compatibility of Li7La3Zr2O12 solid electrolyte to all-solid-state battery using Li metal anode. J Electrochem Soc. 157 A1076-A1079 (2010).
34. Padhi A, Nanjundaswamy K, Masquelier C, Okada S, et al. Effect of structure on the Fe3+/Fe2+ redox couple in iron phosphates. J Electrochem Soc. 144 1609-1613 (1997).
35. Ye T, Barpanda P, Nishimura S-i, Furuta N, et al. General observation of Fe3+/Fe2+ redox couple close to 4 V in partially substituted Li2FeP2O7 pyrophosphate solid-solution cathodes. Chem Mater. 25 3623-3629 (2013).
36. Jung R, Metzger M, Maglia F, Stinner C, et al. Oxygen release and its effect on the cycling stability of LiNixMnyCozO2 (NMC) cathode materials for Li-ion batteries. J Electrochem Soc. 164 A1361-A1377 (2017).
37. Li J, Downie L E, Ma L, Qiu W, et al. Study of the failure mechanisms of LiNi0. 8Mn0. 1Co0. 1O2 cathode material for lithium ion batteries. J Electrochem Soc. 162 A1401-A1408 (2015).
38. Noh H-J, Youn S, Yoon C S, Sun Y-K. Comparison of the structural and electrochemical properties of layered Li [NixCoyMnz] O2 (x=1/3, 0.5, 0.6, 0.7, 0.8 and 0.85) cathode material for lithium-ion batteries. J Power Sources. 233 121-130 (2013).
39. Jung R, Metzger M, Maglia F, Stinner C, et al. Chemical versus electrochemical electrolyte oxidation on NMC111, NMC622, NMC811, LNMO, and Conductive Carbon. The journal of physical chemistry letters. 8 4820-4825 (2017).
40. Zhao Q, Liu X, Stalin S, Khan K, et al. Solid-state polymer electrolytes with in-built fast interfacial transport for secondary lithium batteries. Nature Energy. 1 (2019).

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A composite solid electrolyte (CSE) comprising:
a plurality of silane-decorated ceramic nanofibers comprising ceramic nanofibers coupled with a silane-coupling agent having an organofunctional group;
a polymeric material; and
a plurality of metal ions.

2. The composite solid electrolyte of claim 1, wherein the polymeric material is polymerized, cross-linked, or both, with the organofunctional group.

3. The composite solid electrolyte of claim 1, wherein the polymeric material is a polymer or copolymer comprising one or more of: polyethylene oxide (PEO), polycarbonate, polysiloxane, polyvinyl chloride (PVC), polyacrylonitrile (PAN), poly(methyl methacrylate) (PMMA), polyvinylidene fluoride (PVDF), Poly(vinylidene fluoride-co-hexafluoropropylene) (PVDF-HFP), polypropylene glycol (PPG), polydimethylsiloxane (PDMS), polyethylene carbonate (PEC), polypropylene carbonate (PPC), polycaprolactone (PCL), polytrimethylene carbonate (PTMC), and combinations thereof.

4. The composite solid electrolyte of claim 1, wherein the polymeric material comprises a poly(ethylene glycol) diacrylate (PEGDA).

5. The composite solid electrolyte of claim 1, wherein the ceramic nanofibers are selected from: garnet-type ceramics, perovskite-type ceramics, NASICON-type ceramics, and sulfide-type ceramics.

6. The composite solid electrolyte of claim 1, wherein the ceramic nanofibers comprise a garnet-type ceramic.

7. The composite solid electrolyte of claim 6, wherein the ceramic nanofibers comprise a garnet-type ceramic selected from: Li₇La₃Zr₂O₁₂ (LLZO), or Li_{6.28}La₃Al_{0.24}Zr₂O₁₂ (LLAZO), and Li6.75La₃Zr_{1.75}Ta_{0.25}O₁₂ (LLZTO).

8. The composite solid electrolyte of claim 1, wherein the plurality of metal ions comprises a lithium-ion salt.

9. The composite solid electrolyte of claim 1, comprising from about 5% to about 70% by weight silane-decorated ceramic nanofibers.

10. The composite solid electrolyte of claim 1, wherein the electrolyte is in sheet form.

11. The composite solid electrolyte of claim 10, wherein the sheet has a thickness of from about 10 microns to about 100 microns.

12. The composite solid electrolyte of claim 10, wherein the electrolyte is flexible and bendable, and has an electrical conductivity of about 10⁻⁷S cm⁻¹ or less.

13. The composite solid electrolyte of claim 1, wherein the silane-coupling agent has a structure:
(RO)₃—Si—R′—X
where: RO is a hydroxyl group or a hydrolysable group such as an alkoxy group; R′ is a C2-C6 alkyl linkage; and X is an organofunctional group.

14. A metallic or metal ion energy storage device comprising:
a composite solid electrolyte comprising a plurality of silane-decorated ceramic nanofibers comprising ceramic nanofibers coupled with a silane-coupling agent having an organofunctional group, a polymeric material, and a plurality of metal ions;
wherein the composite solid electrolyte is operably coupled with an anode and a cathode.

15. The energy storage device of claim 14, comprising a lithium-ion energy storage device.

16. The energy storage device of claim 14, wherein the composite solid electrolyte is coated on one of the anode and the cathode.

17. The energy storage device of claim 14, wherein the cathode comprises a material selected from: Lithium Iron Phosphate (LiFePO₄) (LFP); Lithium Nickel Manganese Cobalt Oxide (LiNiMnCoO₂) (NMC); Lithium-Sulfur (Li-S); Lithium Cobalt Oxide (LiCoO₂) (LCO); Lithium Manganese Oxide (LiMn₂O₄) (LMO); Lithium Nickel Cobalt Aluminum Oxide (LiNiCoAlO₂) (NCA); and Lithium-Air.

18. A method for making a composite solid electrolyte (CSE) comprising:
combining a plurality of silane-decorated ceramic nanofibers comprising ceramic nanofibers coupled with a silane-coupling agent having an organofunctional group with a polymeric material or prepolymer material, and a plurality of metal ions to form a mixture;
forming a film with the mixture; and
polymerizing the mixture to provide a polymer matrix comprising the silane-decorated ceramic nanofibers and the polymeric material.

19. The method of claim 18, further comprising:
coating a plurality of ceramic nanofibers with a silane-coupling agent having an organofuctional group to provide a plurality of silane-decorated ceramic nanofibers.
